(19) United States
(12) Patent Application Publication
(10) Pub. No.: US 2024/0385007 A1
(43) Pub. Date: Nov. 21, 2024

(54) CONTROL SYSTEM, CONTROL METHOD, AND STORAGE MEDIUM

(71) Applicant: CANON KABUSHIKI KAISHA, Tokyo (JP)

(72) Inventor: Yohei Sato, Kanagawa (JP)

(21) Appl. No.: 18/789,923

(22) Filed: Jul. 31, 2024

Related U.S. Application Data
(63) Continuation-in-part of application No. PCT/JP2023/002535, filed on Jan. 26, 2023.

(30) Foreign Application Priority Data
Feb. 1, 2022 (JP) 2022-014166
Jul. 22, 2022 (JP) 2022-117189
Jan. 10, 2023 (JP) 2023-001617

(51) Int. Cl. G01C 21/36

(52) U.S. Cl. CPC G01C 21/3691

(57) ABSTRACT

A control system including a control unit configured to giving a control instruction to at least one or more mobile objects; and a conversion information storing unit configured to convert space information including information relating to a type of object present in a space defined using a first reference system and information relating to a time into a format in association with a unique identifier and storing the format, in which the conversion information storing unit is able to convert space information including information relating to a type of object present in a space defined using a second reference system different from the first reference system and information relating to a time into a format in association with a unique identifier and store the format, the control system further including an association unit configured to associate the second reference system with the first reference system, and the control unit generates route information relating to a movement route of the mobile object on the basis of the space information acquired from the conversion information storing unit and the type information of the mobile object.

### BACKGROUND

### Field

The present invention relates to a control system, a control method, a storage medium, and the like.

### Description of the Related Art

In recent years, in accordance with technological innovations of autonomous mobility, spatial recognition systems, and the like, developments of overall structures (hereinafter referred to as digital architectures) that connect data and systems between different organizations and members of a society have been progressed in the world.

For example, in Japanese Patent Laid-Open No. 2021-157283, in mobility technologies of an autonomous mobility, map information of a wide region and a local map that is perceived by the autonomous mobility at a close position are included, a wide-region map is handled using a global coordinate system, and the local map is handled using a local coordinate system.

However, the local coordinate system used in the technology of Japanese Patent Laid-Open No. 2021-157283 described above is set for being used by an autonomous mobility itself, and there is a problem that the local coordinate system does not become a reference for achieving sharing of position information with other devices.

### SUMMARY OF THE DISCLOSURE

There is provided a control system as one aspect of the present invention including: a control unit configured to give a control instruction to at least one or more mobile objects; and a conversion information storing unit configured to convert space information including information relating to a type of object present in a space defined using a first reference system and information relating to a time into a format in association with a unique identifier and storing the format, in which the conversion information storing unit is able to convert space information including information relating to a type of object present in a space defined using a second reference system different from the first reference system and information relating to a time into a format in association with a unique identifier and store the format, the control system further including an association unit configured to associate the second reference system with the first reference system, and the control unit generates route information relating to a movement route of the mobile object on the basis of the space information acquired from the conversion information storing unit and the type information of the mobile object.

Further features of the present disclosure will become apparent from the following description of embodiments with reference to the attached drawings.

### BRIEF DESCRIPTION OF THE DRAWINGS

FIG. 1 is a diagram illustrating a configuration example of an entire autonomous mobility control system according to a first embodiment of the present invention.

FIG. 2A illustrates an example of an input screen at the time of a user's inputting position information, and FIG. 2B is a diagram illustrating an example of a selection screen used for selecting an autonomous mobility to be used.

FIG. 3A is a diagram illustrating an example of a screen used for checking a current position of an autonomous mobility, and FIG. 3B is a diagram illustrating an example of a map display screen at the time of checking a current position of an autonomous mobility.

FIG. 4 is a block diagram illustrating an internal configuration example of each device illustrated in FIG. 1.

FIG. 5A is a diagram illustrating a spatial positional relation between an autonomous mobility 12 and a pillar 99 present as feature information in the vicinity thereof in a real world, and FIG. 5B is a diagram illustrating a state in which the autonomous mobility 12 and the pillar 99 are mapped into an arbitrary XYZ coordinate system space having P0 as its origin.

FIG. 6 is a perspective view illustrating a mechanical configuration example of an autonomous mobility 12 according to a first embodiment.

FIG. 7 is a block diagram illustrating a specific hardware configuration example of each of control units 10-2, 11-2, 12-2, 13-2, 14-3, and 15-2.

FIG. 8 is a sequence diagram describing a process performed by the autonomous mobility control system according to the first embodiment.

FIG. 9 is a sequence diagram continued from FIG. 8.

FIG. 10 is a sequence diagram continued from FIG. 9.

FIG. 11A is a diagram illustrating latitude/longitude information of the Earth, and FIG. 11B is a perspective view illustrating a predetermined space 100 of FIG. 11A.

FIG. 12 is a diagram schematically illustrating space information of the inside of the space 100.

FIG. 13A is a diagram in which route information is displayed in map information, FIG. 13B is a diagram in which route information using position point group data is displayed in map information, and FIG. 13C is a diagram in which route information using unique identifiers is displayed in map information.

FIG. 14 is a hierarchical structure diagram of each reference system.

FIG. 15 is a hierarchical structure diagram representing a relationship between a local reference system 510 and an indoor reference system 520 in detail.

FIG. 16 is a flowchart from generation to registration of a reference system.

FIG. 17 is a flowchart of an operation of an autonomous mobility performing movement crossing over reference systems.

### DESCRIPTION OF THE EMBODIMENTS

Hereinafter, with reference to the accompanying drawings, favorable modes of the present invention will be described using Embodiments. In each diagram, the same reference signs are applied to the same members or elements, and duplicate description will be omitted or simplified.

Although an example in which the present invention is applied to control of an autonomous mobility will be described in the embodiment, a mobile object may be configured to be able to be operated at least in a part by a user with respect to movement of the mobile object. In other words, for example, a configuration in which various displays and the like relating to a movement route and the like are performed for a user, and the user performs a part of a driving operation of the mobile object by referring to the displays may be employed.

### First Embodiment

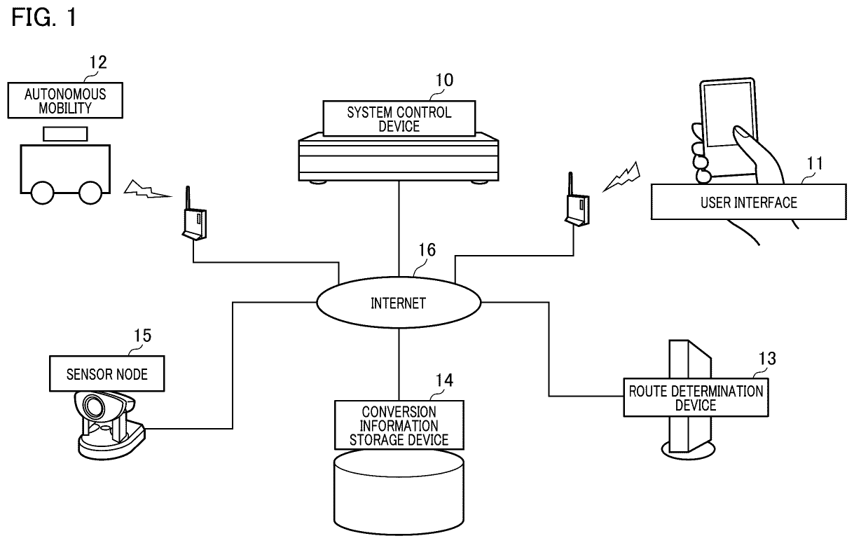

FIG. 1 is a diagram illustrating a configuration example of an entire autonomous mobility control system according to a first embodiment of the present invention. As illustrated in FIG. 1, the autonomous mobility control system (it may be abbreviated to a control system) according to this embodiment includes a system control device 10, a user interface 11, an autonomous mobility 12, a route determining device 13, a conversion information storing device 14, a sensor node 15, and the like. Here, the user interface 11 represents a user terminal device.

In this embodiment, devices illustrated in FIG. 1 are connected using network connection parts thereof to be described below through the Internet 16. However, for example, another network system such as a local area network (LAN) may be used.

Some of the system control device 10, the user interface 11, the route determining device 13, the conversion information storing device 14, and the like may be configured as the same device. The user interface 11, the route determining device 13, the conversion information storing device 14, and the like function as a control unit for performing a control process giving a control instruction to at least one or more autonomous mobilities.

Each of the system control device 10, the user interface 11, the autonomous mobility 12, the route determining device 13, the conversion information storing device 14, and the sensor node 15 includes an information processing device that is formed from a CPU as a computer, and a ROM, a RAM, an HDD, and the like as storage media. Details of the function and the internal configuration of each device will be described below.

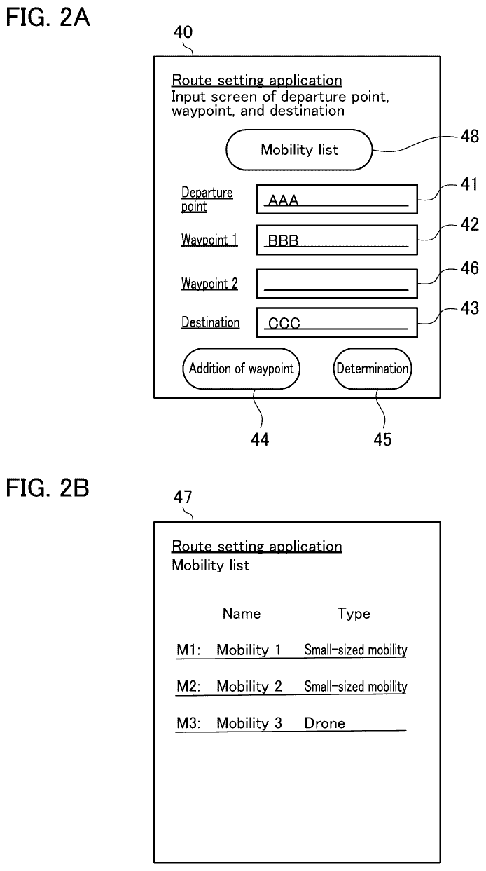

Next, service application software (hereinafter, it will be abbreviated to an application) provided by the autonomous mobility control system described above will be described. In description, first, screen images displayed in the user interface 11 when a user inputs position information will be described with reference to FIGS. 2A and 2B.

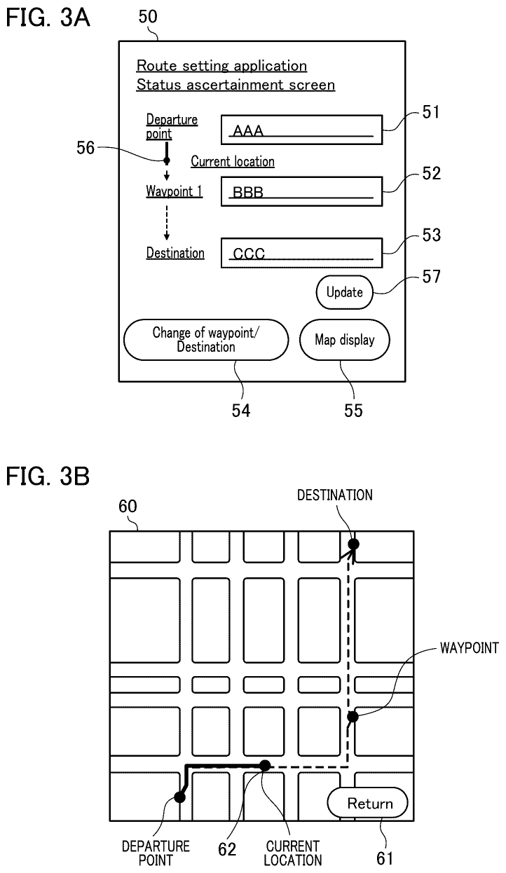

Subsequently, screen images displayed in the user interface 11 when a user reads a current position of the autonomous mobility 12 will be described with reference to FIGS. 3A and 3B. By using such description, the way the application is operated in the autonomous mobility control system described above will be described using an example.

In this description, for the convenience of description, although a map display will be described on a two-dimensional plane, a user can designate a three-dimensional position also including “height”, and also input “height” information in this embodiment. In other words, according to this embodiment, a three-dimensional map can be generated.

FIG. 2A illustrates an example of an input screen at the time of a user's inputting position information, and FIG. 2B is a diagram illustrating an example of a selection screen used for selecting an autonomous mobility to be used. When a user accesses the Internet 16 and selects, for example, a route setting application of the autonomous mobility control system by operating the display screen of the user interface 11, a web page of the system control device 10 is displayed.

An input screen 40 of a departure place, a via point, and a destination place for setting the departure place, the via point, and the destination place at the time of moving the autonomous mobility 12 is displayed first on the web page. There is a list display button 48 used for displaying a list of autonomous mobilities (mobile objects) to be used on the input screen 40, and when a user presses the list display button 48, as illustrated in FIG. 2B, a list display screen 47 of mobilities is displayed.

First, a user selects an autonomous mobility (mobile object) to be used on the list display screen 47. For example, although mobilities M1 to M3 are displayed to be selectable on the list display screen 47, the number of mobilities is not limited thereto.

When the user selects one of the mobilities M1 to M3 through a click operation or the like, the screen automatically returns to the input screen 40 illustrated in FIG. 2A. In addition, the selected mobility name is displayed in the list display button 48. Thereafter, the user inputs a place to be set as a departure place to an input field 41 of “Departure Place”.

In addition, the user inputs a place to be set as a via point to an input field 42 of “Via Point 1”. Furthermore, a via point can be added, and when an add button 44 of a via point is pressed once, an input field 46 of “Via Point 2” is additionally displayed, and a via point to be added can be input.

When the add button 44 of a via point is pressed, like “Via Point 3” and “Via Point 4”, input fields 46 are additionally displayed, and a plurality of places of via points to be added can be input. In addition, a user inputs a place to be set as a destination place to an input field 43 of “Destination Place”. Although not illustrated, when the input fields 41 to 43, 46 and the like are clicked, a keyboard or the like used for inputting characters are temporarily displayed to enable input of desired characters.

Then, by pressing a select button 45, a user can set a movement route of the autonomous mobility 12. In the example illustrated in FIG. 2, “AAA” is set as the departure place, “BBB” is set as the via point 1, and “CCC” is set as the destination place. Words input to an input field, for example, may be an address or the like or position information for representing a specific position such as latitude/longitude information, a store name, or a telephone number may be configured to input to the input field.

FIG. 3A is a diagram illustrating an example of a screen used for checking a current position of an autonomous mobility, and FIG. 3B is a diagram illustrating an example of a map display screen at the time of checking a current position of an autonomous mobility.

A checking screen 50 is illustrated in FIG. 3A, and the checking screen is displayed by operating an operation button not illustrated in the drawing after a movement route of the autonomous mobility 12 is set on the screen as illustrated in FIG. 2A. On the checking screen 50, a current position of the autonomous mobility 12, for example, is displayed on the web page of the user interface 11 as a current place 56. Thus, the user can easily perceive the current position.

In addition, by pressing an update button 57, the user can display a latest state by updating screen display information. Furthermore, by pressing a via point/destination place change button 54, the user can change the departure place, the via point, and the destination place. In other words, by inputting a place desired to be reset to each of the input field 51 of “departure place”, the input field 52 of “via point 1”, and the input field 53 of “destination place”, a corresponding place or point can be changed.

FIG. 3B illustrates an example of a map display screen 60 switched from the checking screen 50 in a case in which a map display button 55 illustrated in FIG. 3A is pressed. The position of the current place 62 is displayed on the map in the map display screen 60, whereby the current place of the autonomous mobility 12 can be checked more easily. In addition, in a case in which the user presses a back button 61, the display screen can be returned to the checking screen 50 illustrated in FIG. 3A.

As above, a user can easily set a movement route used for moving the autonomous mobility 12 from a predetermined place to a predetermined place through an operation of the user interface 11. In addition, such a route setting application, for example, can be applied also to a taxi dispatching service, a home delivery service using a drone, and the like.

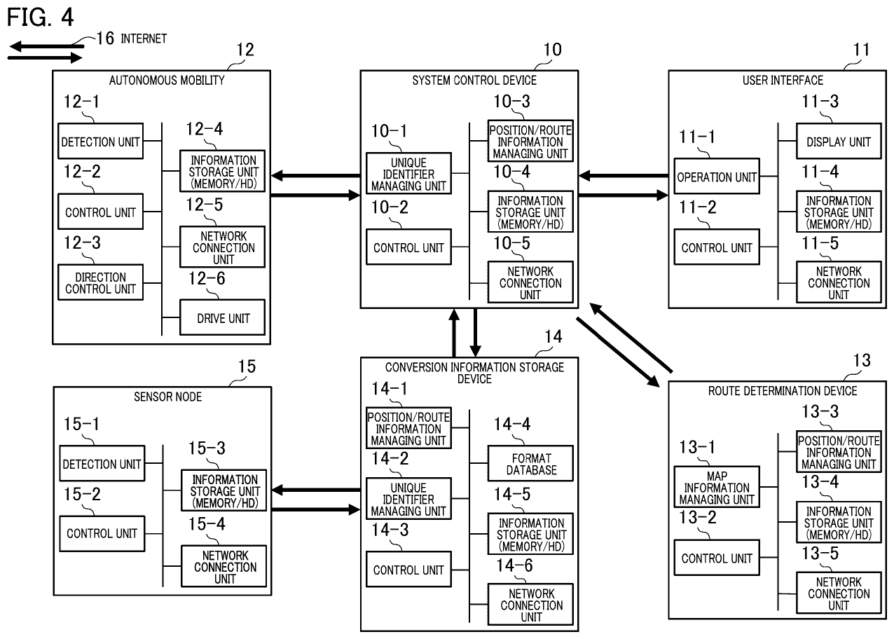

Next, configuration examples and function examples of the devices 10 to 15 illustrated in FIG. 1 will be described in detail with reference to FIG. 4. FIG. 4 is a block diagram illustrating an internal configuration example of each device illustrated in FIG. 1.

As illustrated in FIG. 4, the user interface 11 includes an operation unit 11-1, a control unit 11-2, a display unit 11-3, an information storing unit (a memory/HD) 11-4, and a network connecting unit 11-5. The operation unit 11-1 is configured using a touch panel, a key button, and the like and is used for inputting data. The display unit 11-3, for example, is a liquid crystal screen or the like and is used for displaying route information and other data.

The display screens of the user interface 11 illustrated in FIGS. 2 and 3 are displayed in the display unit 11-3. A user can perform selection of a route, input of information, checking of information, and the like using a menu displayed in the display unit 11-3.

In other words, the operation unit 11-1 and the display unit 11-3 provide interfaces used for operations for a user's actual operations. In addition, instead of separately providing the operation unit 11-1 and the display unit 11-3, a touch panel may be used to function as both the operation unit and the display unit.

The control unit 11-2 has a CPU as a computer built thereinto and controls a communication process by performing management of each application and mode management such as of information input, information checking, and the like in the user interface 11. In addition, the control unit 11-2 controls a process of each unit disposed inside the system control device.

The information storing unit (memory/HD) 11-4, for example, is a database used for storing necessary information such as a computer program for being executed by the CPU. The network connecting unit 11-5 controls communication performed through the Internet, a LAN, a wireless LAN, or the like. In addition, the user interface 11, for example, may be a device such as a smartphone or may be in a form such as a tablet terminal.

In this way, the user interface 11 according to this embodiment displays the departure place, the via point, and the destination place described above on the input screen 40 of the browser screen of the system control device 10, and a user's input of position information such as a departure place, a via point, and a destination place can be performed. In addition, by displaying the checking screen 50 and the map display screen 60 described above on the browser screen described above, the current position of the autonomous mobility 12 can be displayed.

The route determining device 13 illustrated in FIG. 4 includes a map information managing unit 13-1, a control unit 13-2, a position/route information managing unit 13-3, an information storing unit (memory/HD) 13-4, and a network connecting unit 13-5. The map information managing unit 13-1 has map information of a wide region, searches for route information representing a route on the map on the basis of predetermined position information that has been designated, and transmits the route information that is a search result to the position/route information managing unit 13-3.

The map information described above is three-dimensional map information including information such as topography and latitude/longitude/altitude and also includes regulation information and the like relating to the road traffic law such as roadway, a sidewalk, a direction of movement, and a traffic regulation.

In addition, for example, regulation information that is changed over time such as a case in which one-way traffic is enforced in accordance with a time frame or a case in which a pedestrian walkway is enforced in accordance with a time frame is also included together with respective time information. The control unit 13-2 has a CPU as a computer built thereinto and controls the process of each unit inside of the route determining device 13.

The position/route information managing unit 13-3 manages position information of an autonomous mobility acquired through the network connecting unit 13-5, transmits the position information described above to the map information managing unit 13-1, and manages the route information described above as a result of the above-described search acquired from the map information managing unit 13-1. In accordance with a request from an external system, the control unit 13-2 converts the above-described route information managed by the position/route information managing unit 13-3 into a predetermined data format and transmits the route information to the external system.

As above, in this embodiment, the route determining device 13 is configured to search for a route compliant with the road traffic law and the like on the basis of designated position information and output route information in a predetermined data format.

The conversion information storing device 14 illustrated in FIG. 4 includes a position/route information managing unit 14-1, a unique identifier managing unit 14-2, a control unit 14-3, a format database 14-4, an information storing unit (a memory/HD) 14-5, and a network connecting unit 14-6.

The position/route information managing unit 14-1 manages predetermined position information acquired through the network connecting unit 14-6 and transmits the position information described above to the control unit 14-3 in accordance with a request from the control unit 14-3. The control unit 14-3 has a CPU as a computer built thereinto and controls the process of each unit inside of the conversion information storing device 14.

The control unit 14-3 converts the position information described above into a unique identifier defined in the format described above on the basis of the above-described position information acquired from the position/route information managing unit 14-1 and information of a format managed by the format database 14-4.

Then, the control unit 14-3 transmits the unique identifier to the unique identifier managing unit 14-2. Although the format described above will be described below in detail, identifiers (hereinafter, unique identifiers) are assigned to a space having a predetermined position as a start point, and the space is managed using the unique identifiers. In this embodiment, a corresponding unique identifier and information of the inside of the space can be acquired on the basis of predetermined position information.

The unique identifier managing unit 14-2 manages the above-described unique identifier converted by the control unit 14-3 and transmits the unique identifier through the network connecting unit 14-6. The format database 14-4 manages the information of the format described above and transmits the information of the format described above to the control unit 14-3 in accordance with a request from the control unit 14-3.

In addition, the above-described information of the inside of the space acquired through the network connecting unit 14-6 is managed using the format described above. The conversion information storing device 14 (a conversion information storing unit) manages an external device, a device, and the above-described information relating to the space acquired through a network in association with a unique identifier. In addition, the conversion information storing device 14 provides the unique identifier and the above-described information relating to the space associated therewith for the external device, the device, and the network.

As above, the conversion information storing device 14 acquires a unique identifier and information of the inside of the space on the basis of predetermined position information and manages and provides the information in a state in which it can be shared among an external device connected thereto, the device, and the network.

In addition, the conversion information storing device 14 converts the above-described position information designated in the system control device 10 into the unique identifier described above and provides the unique identifier described above for the system control device 10.

As illustrated in FIG. 4, the system control device 10 includes a unique identifier managing unit 10-1, a control unit 10-2, a position/route information managing unit 10-3, an information storing unit (a memory/HD) 10-4, and a network connecting unit 10-5. The position/route information managing unit 10-3 stores simple map information in which topography information and latitude/longitude information are associated with each other and manages the predetermined position information and the route information acquired through the network connecting unit 10-5.

In addition, the position/route information managing unit 10-3 can divide the route information described above at a predetermined interval and generate position information such as a latitude/longitude of each divided place. The unique identifier managing unit 10-1 manages information acquired by converting the position information described above and the route information described above into the unique identifier described above.

The control unit 10-2 has a CPU as a computer built thereinto, is responsible for control of a communication function of the above-described position information, the above-described route information, and the above-described unique identifier of the system control device 10, and controls the process of each unit inside of the system control device 10.

In addition, the control unit 10-2 provides a web page for the user interface 11 and transmits predetermined position information acquired from the web page to the route determining device 13. Furthermore, the control unit 10-2 acquires predetermined route information from the route determining device 13 and transmits each piece of position information of the route information to the conversion information storing device 14. Then, the route information converted into the unique identifier acquired from the conversion information storing device 14 is transmitted to the autonomous mobility 12.

As above, the system control device 10 is configured to be able to perform acquisition of predetermined position information designated by a user, transmission/reception of position information and route information, generation of position information, and transmission/reception of route information using a unique identifier.

In addition, the system control device 10 collects the above-described route information that is necessary for the autonomous mobility 12 to perform autonomous movement on the basis of the above-described position information input to the user interface 11 and provides route information using the unique identifier to the autonomous mobility 12. In this embodiment, the system control device 10, the route determining device 13, and the conversion information storing device 14, for example, function as servers.

As illustrated in FIG. 4, the autonomous mobility 12 includes a detection unit 12-1, a control unit 12-2, a direction control unit 12-3, an information storing unit (a memory/HD) 12-4, a network connecting unit 12-5, and a drive unit 12-6. The detection unit 12-1, for example, has a plurality of imaging elements and has a function of performing distance measurement on the basis of a phase difference between a plurality of imaging signals acquired from the plurality of imaging elements.

In addition, the detection unit 12-1 has a self-position estimating function of acquiring detection information such as obstacles including peripheral topography/walls of buildings (hereinafter referred to as detection information) and estimating a self-position on the basis of the detection information and the map information.

In addition, the detection unit 12-1 has the self-position detecting function of a global positioning system (GPS) or the like and a direction detecting function, for example, of a geomagnetic sensor or the like. Furthermore, the control unit 12-2 described above can generate a three-dimensional map of a cyber space on the basis of the acquired detection information, self-position estimation information, and direction detection information.

Here, as the three-dimensional map of the cyber space, space information that is equivalent to feature positions of the real world can be represented as digital data. Inside the three-dimensional map of this cyber space, an autonomous mobility 12 present in the real world and feature information of the vicinity thereof are maintained as information that is spatially equivalent as digital data. Thus, by using this digital data, efficient movement can be performed.

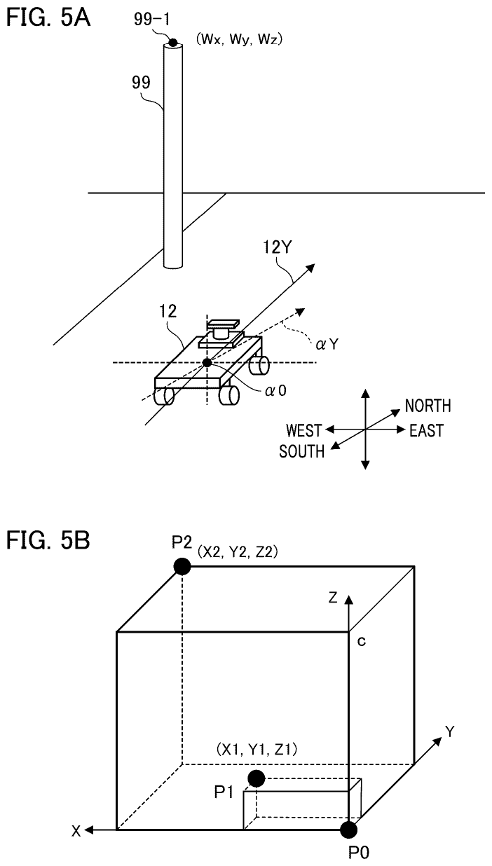

Hereinafter, a three-dimensional map of a cyber space used in this embodiment will be described with reference to FIG. 5 as an example. FIG. 5A is a diagram illustrating a spatial positional relation between an autonomous mobility 12 and a pillar 99 present as feature information in the vicinity thereof in a real world, and FIG. 5B is a diagram illustrating a state in which the autonomous mobility 12 and the pillar 99 are mapped into an arbitrary XYZ coordinate system space having P0 as its origin.

In FIGS. 5A and 5B, the position of the autonomous mobility 12 is identified as a position α0 inside the autonomous mobility 12 from position information of the latitude/longitude acquired using a GPS, which is not illustrated, or the like mounted in the autonomous mobility 12. In addition, the azimuth of the autonomous mobility 12 is identified using a difference between an azimuth αY acquired using an electronic compass or the like, which is not illustrated in the drawing, and a movement direction 12Y of the autonomous mobility 12.

In addition, the position of the pillar 99 is identified as a position of an apex 99-1 from position information measured in advance. In addition, a distance from α0 of the autonomous mobility 12 to the apex 99-1 can be acquired using a distance measurement function of the autonomous mobility 12. In FIG. 5A, in a case in which the movement direction 12Y is set as an axis of an XYZ coordinate system, and α0 is set as an origin, the position is represented as coordinates (Wx, Wy, Wz) of the apex 99-1.

In a three-dimensional map of a cyber space, the information acquired in this way is managed as digital data and can be reconfigured as space information as illustrated in FIG. 5B by the system control device 10, the route determining device 13, and the like.

FIG. 5B illustrates a state in which the autonomous mobility 12 and the pillar 99 are mapped into an arbitrary XYZ coordinate system space having P0 as its origin. By setting P0 to predetermined latitude/longitude in a real world and taking the north of the azimuth in the real world as the direction of a Y axis, the autonomous mobility 12 and the pillar 99 can be expressed as P1 and P2 in this arbitrary XYZ coordinate system space.

More specifically, the position P1 of α0 in this space can be calculated from the latitude/longitude of α0 and the latitude/longitude of P0. Similarly, the pillar 99 can be calculated as P2. In this example, although two objects including the autonomous mobility 12 and the pillar 99 are expressed using a three-dimensional map of a cyber space, it is apparent that more objects can be similarly handled. As above, a three-dimensional map is a map acquired by mapping a self-position and objects of a real world into a three-dimensional space.

Referring back to FIG. 4, the autonomous mobility 12 stores learning result data of object detection acquired by performing machine learning, for example, in the information storing unit (the memory/HD) 12-4 and can detect objects from a captured image using machine learning.

In addition, the detection information described above can be acquired from an external system through the network connecting unit 12-5 and also can be reflected on a three-dimensional map. Furthermore, the control unit 12-2 has a CPU as a computer built thereinto, is responsible for controlling movement, a direction change, and an autonomous traveling function of the autonomous mobility 12, and controls the process of each unit inside of the autonomous mobility 12.

The direction control unit 12-3 changes a movement direction of the autonomous mobility 12 by changing a driving direction of the autonomous mobility according to the drive unit 12-6. The drive unit 12-6 is formed from a drive device such as a motor and generates a propelling force of the autonomous mobility 12. The autonomous mobility 12 reflects the self-position and the detection information described above and object detection information in the three-dimensional map described above, generates a route maintaining a predetermined gap from peripheral topography, buildings, obstacles, and objects, and can perform autonomous traveling.

In addition, the route determining device 13 performs route generation in consideration of regulation information mainly relating to the road traffic law. On the other hand, the autonomous mobility 12 detects a position of an obstacle present in the vicinity thereof in a route according to the route determining device 13 more accurately and generates a route for moving without being in contact therewith on the basis of the size thereof.

In addition, the autonomous mobility 12 can store a mobility model of the autonomous mobility itself as well in the information storing unit (the memory/HD) 12-4 of the autonomous mobility 12. This mobility model, for example, is a type of mobility body that is legally identified and, for example, represents a type such as a vehicle, a bicycle, or a drone. Generation of format route information to be described below can be performed on the basis of this mobility model.

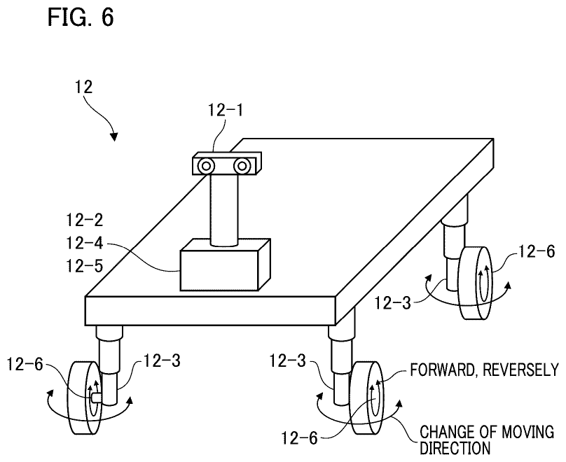

Here, a main body configuration of the autonomous mobility 12 according to this embodiment will be described with reference to FIG. 6. FIG. 6 is a perspective view illustrating a mechanical configuration example of the autonomous mobility 12 according to the embodiment. In this embodiment, although an example in which the autonomous mobility 12 is a traveling body having vehicle wheels is described, the configuration is not limited thereto, and the autonomous mobility 12 may be a flying object such as a drone.

The detection unit 12-1, the control unit 12-2, the direction control unit 12-3, the information storing unit (the memory/HD) 12-4, the network connecting unit 12-5, and the drive unit 12-6 are mounted in the autonomous mobility 12 illustrated in FIG. 6, and the units are electrically connected to each other. At least two or more drive units 12-6 and direction control units 12-3 are arranged in the autonomous mobility 12.

The direction control unit 12-3 changes the movement direction of the autonomous mobility 12 by changing the direction of the drive unit 12-6 through rotation driving of an axis, and the drive unit 12-6 performs a forward movement and a backward movement of the autonomous mobility 12 through rotation of the axis. The configuration described using FIG. 6 is one example and is not limited thereto and, for example, change of the movement direction may be performed using an omni-wheel or the like.

The autonomous mobility 12, for example, is a mobile object using a simultaneous localization and mapping (SLAM) technology. In addition, the autonomous mobility 12 is configured to autonomously move along a designated predetermined route on the basis of the detection information detected by the detection unit 12-1 and detection information of an external system acquired through the Internet 16.

The autonomous mobility 12 can perform trace movement in which places designated in detail are traced or can move by passing places that are roughly set and generating route information by itself in a space therebetween.

As above, the autonomous mobility 12 according to this embodiment can perform autonomous movement on the basis of the route information using the above-described unique identifier provided by the system control device 10.

Referring back to FIG. 4, the sensor node 15, for example, is an external system such as a video monitoring system like a roadside camera unit and includes a detection unit 15-1, a control unit 15-2, an information storing unit (a memory/HD) 15-3, and a network connecting unit 15-4. The detection unit 15-1, for example, acquires detection information of an area that can be detected by itself as a camera and has an object detection function and a distance measurement function.

The control unit 15-2 has a CPU as a computer built thereinto, is responsible for controlling detection of the sensor node 15, data storage, and a data transmission function, and controls the process of each unit inside of the sensor node 15. In addition, the control unit 15-2 stores the detection information acquired by the detection unit 15-1 in the information storing unit (the memory/HD) 15-3 and transmits the detection information to the conversion information storing device 14 through the network connecting unit 15-4.

As above, the sensor node 15 is configured to be able to store detection information such as image information detected by the detection unit 15-1, feature point information of a detected object, and position information in the information storing unit 15-3 and perform communication. In addition, the sensor node 15 provides the above-described detection information of an area that can be detected thereby for the conversion information storing device 14 described below.

Next, a specific hardware configuration of each control unit illustrated in FIG. 4 will be described above.

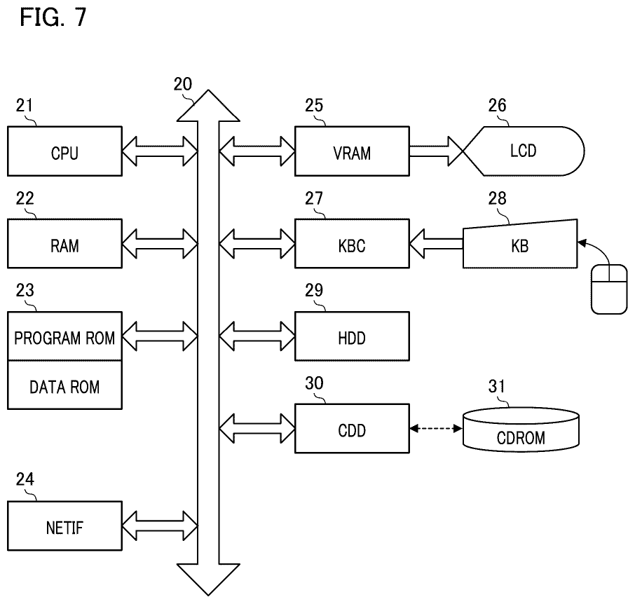

FIG. 7 is a block diagram illustrating a specific hardware configuration example of each of the control units 10-2, 11-2, 12-2, 13-2, 14-3, and 15-2.

In FIG. 7, a CPU 21 as a computer responsible for an arithmetic operation/control of the information processing device is illustrated. A RAM 22 is a main memory of the CPU 21 and functions as an area of an execution program, an execution area of this program, and a data area. A ROM 23 stores an operation processing sequence of the CPU 21.

The ROM 23 includes a program ROM in which basic software (OS) that is a system program controlling an information processing device is recorded and a data ROM in which information and the like required for starting up the system are recorded. In addition, an HDD 29 to be described below may be used in place of the ROM 23.

A network interface (NETIF) 24 performs control for data transmission between information processing devices through the Internet 16 and a diagnosis of a connection status. A video RAM (VRAM) 25 develops an image used for being displayed on the screen of an LCD 26 and controls the display thereof. A display device (hereinafter, referred to as an LCD) 26 such as a display is illustrated.

A controller 27 is a controller (hereinafter, referred to as KBC) that is used for controlling an input signal from an external input device 28. The external input device 28 (hereinafter, referred to as KB) is used for receiving an operation performed by a user, and, for example, a pointing device such as a keyboard or a mouse is used.

A hard disk drive (hereinafter, referred to as an HDD) 29 is used for storing an application program and various kinds of data. An application program according to this embodiment is a software program or the like that executes various processing functions according to this embodiment.

A CDD 30 is used for inputting/outputting data to/from a removable medium 31 as a removable data recording medium, for example, such as a CDROM drive, a DVD drive, or a Blu-Ray (registered trademark) disk drive.

The CDD 30 is one example of the external input/output device. The CDD 30 is used in a case in which the application program described above is read from a removable medium or the like. The removable medium 31 is read by the CDD 30 and, for example, is a removable medium such as a CDROM disc, a DVD, a Blu-Ray disk, or the like.

In addition, the removable medium may be a magneto-optical recording medium (for example, an MO), a semiconductor recording medium (for example, a memory card), or the like. Furthermore, an application program and data stored in the HDD 29 may be used by storing them in the removable medium 31. A transmission bus 20 (an address bus, a data bus, an input/output bus, and a control bus) for connecting the units described above is illustrated.

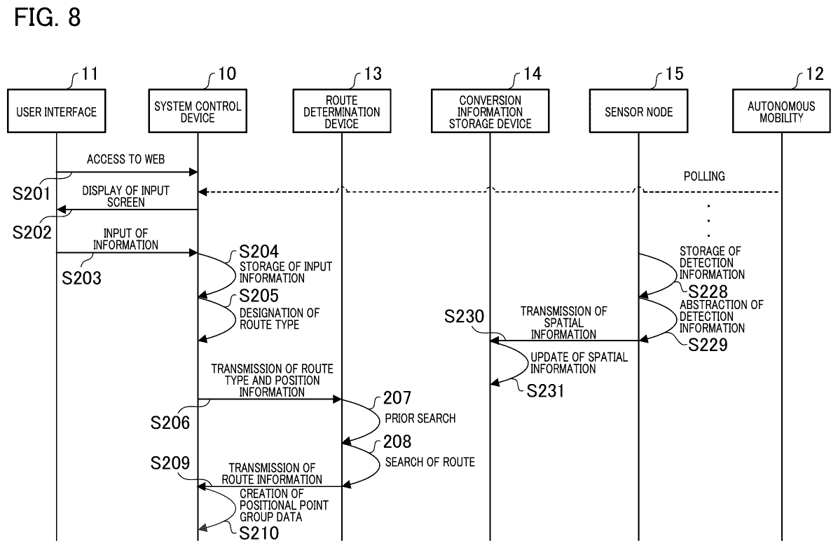

Next, details of a control operation in an autonomous mobility control system for realizing the route setting application and the like as described with reference to FIGS. 2 and 3 will be described with reference to FIGS. 8 to 10.

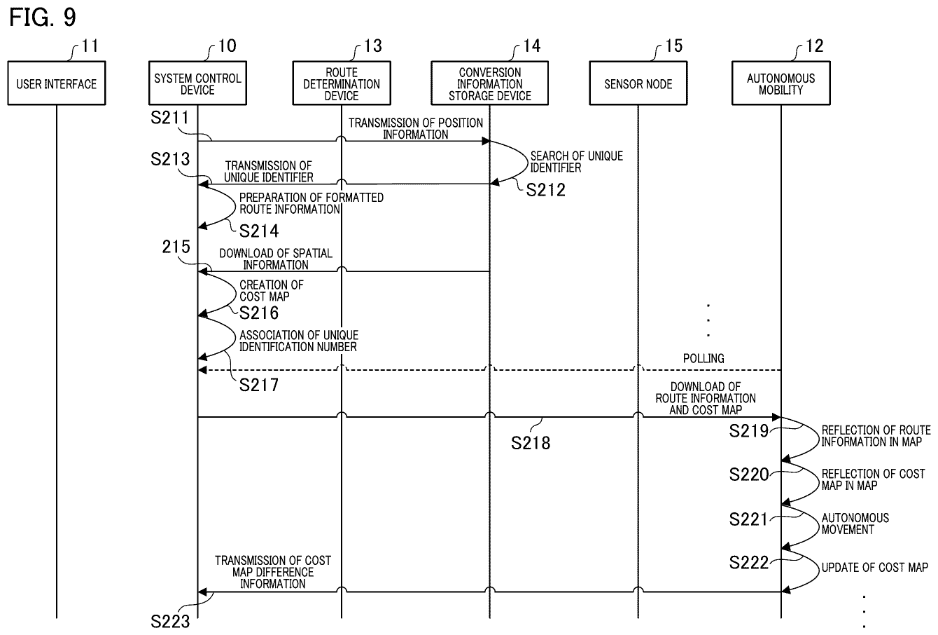

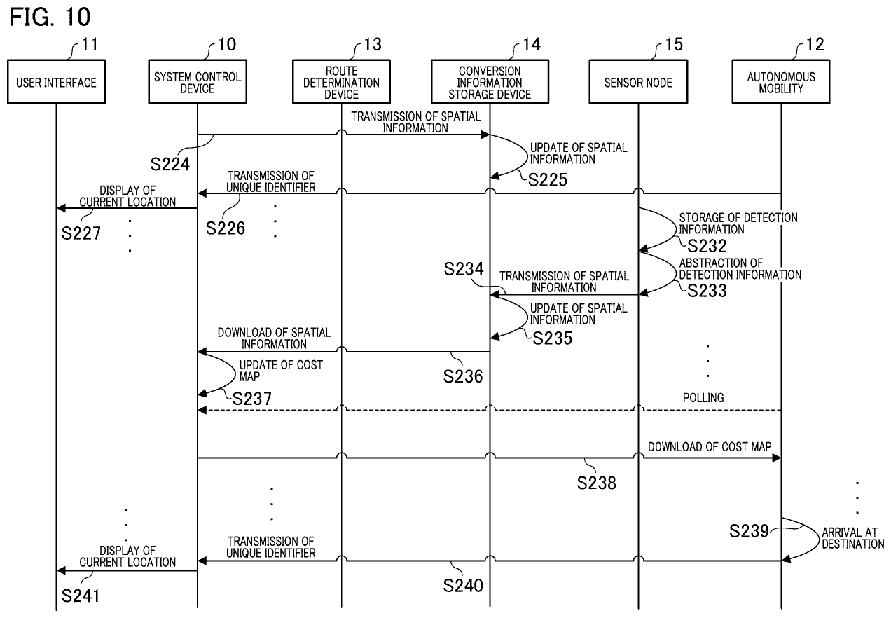

FIG. 8 is a sequence diagram describing a process performed by the autonomous mobility control system according to this embodiment, FIG. 9 is a sequence diagram continued from FIG. 8, and FIG. 10 is a sequence diagram continued from FIG. 9.

FIGS. 8 to 10 illustrate processes executed by respective devices until a user receives current position information of the autonomous mobility 12 after inputting the position information described above to the user interface 11. In addition, a computer inside of a control unit inside of each device executes a computer program stored in a memory, thereby performing the operation of each step of the sequences illustrated in FIGS. 8 to 10.

First, in Step S201, a user accesses a web page provided by the system control device 10 using the user interface 11. In Step S202, the system control device 10 causes the position input screen as described in FIG. 2 to be displayed on the display screen of the web page. In Step S203, as described in FIG. 2, a user selects an autonomous mobility (mobility) and inputs position information representing departure/via/destination places (hereinafter, referred to position information).

The position information described above may be words designating a specific place (hereinafter, they will be referred to as position words), for example, such as a building name, a station name, or an address, or a technique designating a specific position in a map displayed on the web page described above as a point (hereinafter, it will be referred to as a point) may be used.

In Step S204, the system control device 10 stores type information of the selected autonomous mobility 12 and the input position information described above. At this time, in a case in which the position information described above is the position words described above, the position words described above are stored, and, in a case in which the position information described above is the point described above, latitude/longitude corresponding to the point are searched for on the basis of the above-described simple map information stored in the position/route information managing unit 10-3, and the latitude/longitude are stored.

Next, in Step S205, the system control device 10 designates a type of a route along which movement can be performed (hereinafter, it will be referred to as a route type) from the mobility model (type) of the autonomous mobility 12 designated by the user. Then, in Step S206, the system control device 10 transmits the route type to the route determining device 13 together with the position information described above.

The mobility model is a type of mobile object that is legally identified and, for example, represents a type such as a vehicle, a bicycle, a drone, or the like. In addition, a type of route, for example, is a general road, an expressway, a motorway, or the like in case of a vehicle and is a predetermined sideway, a side strip of a general road, a bike lane, or the like in case of a bicycle.

In Step S207, the route determining device 13 inputs the above-described position information that has been received to owned map information as departure/via/destination places. In a case in which the position information described above is the position words described above, latitude/longitude are searched from the map information using the position words, and corresponding latitude/longitude information is used. In a case in which the position information described above is latitude/longitude information, it is directly input to map information to be used.

Subsequently, in Step S208, the route determining device 13 searches for a route from the departure place to the destination place by way of the via place. At this time, as the route to be searched for, a route compliant with the route type described above is searched for. Then, in Step S209, the route determining device 13 outputs a route from the departure place to the destination place by way of the via place (hereinafter, it will be referred to as route information) in a GPS eXchange format (GPX format) as a result of the search and transmits the route information to the system control device 10.

A file of the GPX format is mainly configured as one of three types including a way point (place information having no order relation), a route (place information having an order relation to which time information has been added), and a track (an aggregate of a plurality of pieces of place information: trajectory).

As attribute values of each position information, latitude/longitude are described, and, as child elements, an altitude or a geoid altitude, a GPS reception status/accuracy, and the like are described. A minimum element required for the GPX file is latitude/longitude information of a single point, and description of the other information is arbitrary. The route described above is output as the route information described above and is an aggregation of place information formed from latitude/longitude having an order relation. In addition, the route information may be in another format as long as it can satisfy the description presented above.

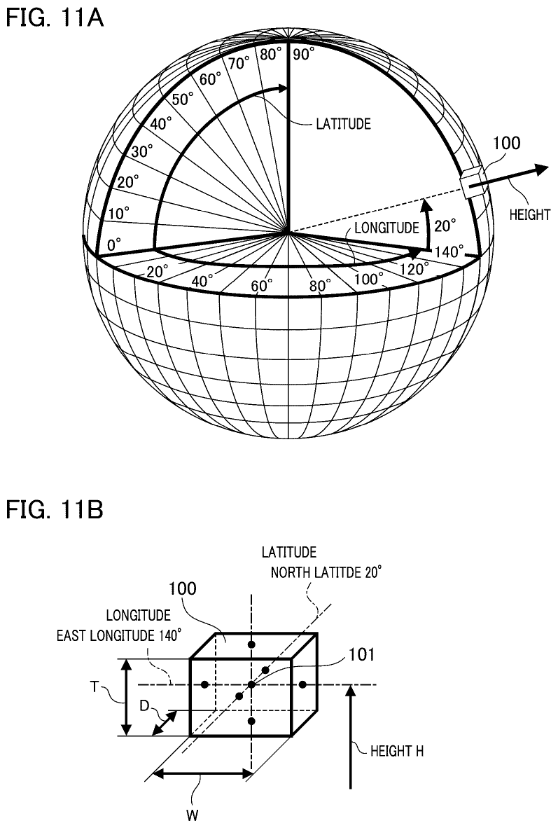

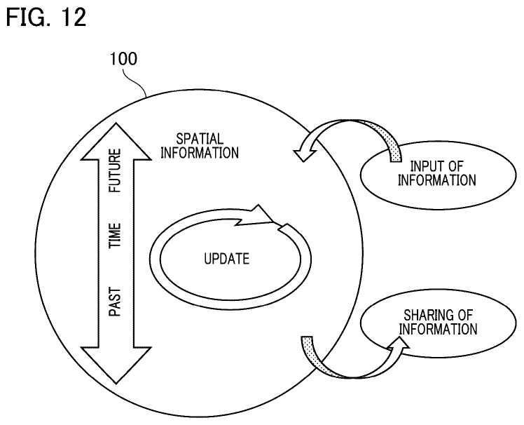

Here, a configuration example of a format managed by a format database 14-4 of the conversion information storing device 14 described above will be described in detail with reference to FIGS. 11A, 11B, and 12.

FIG. 11A is a diagram illustrating latitude/longitude information of the Earth, and FIG. 11B is a perspective view illustrating a predetermined space 100 of FIG. 11A. In FIG. 11B, the center of the predetermined space 100 will be set as a center 101. FIG. 12 is a diagram schematically illustrating space information of the inside of the space 100.

In FIGS. 11A and 11B, in the format, the space of the Earth is divided into three-dimensional spaces determined in accordance with a range having latitude/longitude/height as its start point, and a unique identifier is added to each of the space such that it can be managed.

For example, here, a space 100 is displayed as a predetermined three-dimensional space. The space 100 is a divided space defined to have its center 101 at 20 degrees north latitude, 140 degrees east longitude, and a height H and defined to have D as its width in the latitude direction, W as its width in the longitude direction, and T as its width in the height direction. In addition, the space is one space acquired by dividing the space of the Earth into spaces determined in accordance with a range having the latitude/longitude/height described above as its start point.

In FIG. 11A, for the convenience of description, although only the space 100 is displayed, it is assumed that spaces defined similar to the space 100 as described above are arranged to be aligned in the latitude/longitude/height directions as described above in the definition of the format. In addition, each of the arranged divided spaces is assumed to have its horizontal position being defined using latitude/longitude, have a lap also in the height direction, and have a position in the height direction being defined using the height.

In addition, although the center 101 of the divided space is set as the start point of the latitude/longitude/height described above in FIG. 11B, the configuration is not limited thereto, and, for example, a corner of the space or the center of the bottom may be set as the start point described above.

Furthermore, the shape may be an approximately rectangular parallelepiped, and, when a case in which the spaces are spread all over the surface of the sphere surface such as the Earth is considered, in a case in which the top face of the rectangular parallelepiped is set to be slightly wider than the bottom face thereof, spaces can be arranged with a smaller gap.

When the space 100 described above in FIG. 12 is used as an example, information relating to a type of object that can be present in or enter the range of the space 100 and time (space information) can be stored in the format database 14-4 described above with being associated with a unique identifier to be formatted. In addition, the formatted space information is stored in a time series from the past to the future.

In other words, the conversion information storing device 14 performs a conversion information storing process of formatting space information relating to a type of object that is present in or can enter a three-dimensional space defined using latitude/longitude/height in association with a unique identifier and storing the formatted information in the format database 14-4.

The space information described above is updated on the basis of information input by an external system (for example, the sensor node 15) connected to the conversion information storing device 14 to be able to communicate therewith and is shared by another external system connected to the conversion information storing device 14 to be able to communicate therewith.

In addition, information of a company/individual having an external system, information of an access method for accessing detection information acquired by an external system, and specification information of detection information such as metadata/a communication mode, and the like of the detection information can be also managed with being associated with a unique identifier as space information.

As above, in this embodiment, information relating to a type of object that can be present in or enter a three-dimensional space defined using latitude/longitude/height and time (hereinafter, it will be referred to as space information) is stored in a database with being formatted in association with a unique identifier. Then, a time space can be managed using the formatted space information.

In addition, in this embodiment, a coordinate system defined using latitude/longitude/height will be used in description as a coordinate system defining the position of a space (voxel). However, the coordinate system is not limited to this, and, for example, various coordinate systems such as an XYZ coordinate system having arbitrary coordinate axes, and a military grid reference system (MGRS) as a coordinate of a horizontal direction can be used.

Other than that, a pixel coordinate system using a pixel position of an image as coordinates or a tile coordinate system in which a predetermined area is divided into units called tiles, and the tiles are expressed by aligning them in X/Y directions can be used as well. In this example, use of at least one of the plurality of coordinate systems described above is included.

Referring back to FIG. 8, continuation of the process performed by the autonomous mobility control system will be described again. In Step S210, the system control device 10 checks a gap between pieces of place information inside of the route information that have been received. Then, position point group data in which the gap of the place information and the gap between start point positions of divided spaces defined in the format are matched to each other (hereinafter, it will be referred to as position point group data) is generated.

At this time, in case in which the gap between place information described above is smaller than the gap between start point positions of the divided spaces described above, the system control device 10 thins out place information inside of the route information described above in accordance with the gap between start point position of divided spaces and sets resultant data as position point group data. In addition, in a case in which the gap of the place information described above is larger than the gap between the start point positions of the divided spaces described above, the system control device 10 interpolates the place information in a range not departing from the route information and sets resultant data as position point group data.

In addition, in this embodiment, when format route information to be described below is generated from position point group data, thinning-out/interpolation of the position point group data is performed such that spaces (=voxels) identified using unique identifiers configuring the format route information are linked together without having any gap therebetween.

However, the configuration is not limited thereto, and a movement route can be set such that at least the gap of place information configuring the position point group data is the gap between positions of start points (=reference points) of divided spaces or more, and the divided spaces are not in touch with each other.

As the gap between pieces of position point group data becomes narrower, the movement route can be designated in more detail, and, on the other hand, the amount of data of the whole movement route is increased. In addition, as the gap between pieces of position point group data becomes larger, the movement route cannot be designated in more detail, and the amount of data of the whole movement route can be suppressed.

In other words, the gap between pieces of position point group data can be appropriately adjusted in accordance with conditions such as instruction granularity of the movement route for the autonomous mobility 12, an amount of data to be handled, and the like. In addition, by partly changing the gap between pieces of position point group data, a more optimal route setting can be performed.

Next, as illustrated in Step S211 illustrated in FIG. 9, the system control device 10 transmits latitude/longitude information of each piece of place information of the position point group point data to the conversion information storing device 14 in order of the route. In addition, in Step S212, the conversion information storing device 14 searches for a unique identifier corresponding to the received latitude/longitude information from the format database 14-4 and transmits the unique identifier to the system control device 10 in Step S213.

In Step S214, the system control device 10 aligns received unique identifiers in the same order as that of the original position point group data and stores them as route information (hereinafter, it will be referred to as format route information) using the unique identifiers. In this way, in Step S214, the system control device 10 acquires space information from a database of the conversion information storing device 14 and generates route information relating to a movement route of the mobile object described above on the basis of the acquired space information and type information of the mobile object.

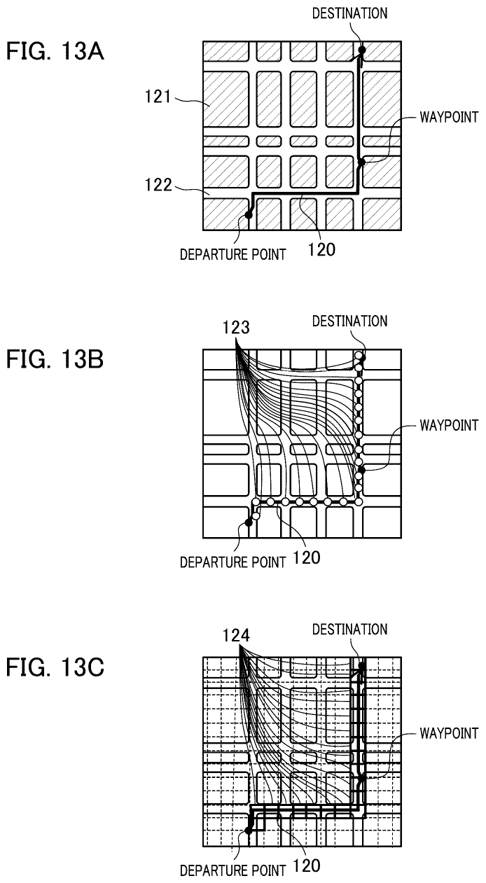

Here, the process of generating the position point group data described above from the route information described above and converting the position point group data into route information using unique identifiers will be described in detail with reference to FIGS. 13A, 13B, and 13C. FIG. 13A is an image diagram in which route information is displayed in map information, FIG. 13B is an image diagram in which route information using position point group data is displayed in map information, and FIG. 13C is a diagram in which route information using unique identifiers is displayed in map information.

In FIG. 13A, route information 120, a restricted area 121 through which the autonomous mobility 12 cannot pass, and a movable area 122 through which the autonomous mobility 12 can move are illustrated. On the basis of position information of a departure place, a via point, and a destination place designated by the user described above, the route information 120 generated by the route determining device 13 described above is generated as a route passing through the departure place, the via point, and the destination place described above and passing through the movable area 122 on map information.

In FIG. 13B, a plurality of pieces of position information 123 on the route information described above are illustrated. The system control device 10 that has acquired the route information 120 described above generates the above-described position information 123 that is disposed on the route information 120 with a predetermined gap.

Each piece of the position information 123 described above can be represented using latitude/longitude/height, and this position information 123 is called position point group data in this embodiment. Then, the system control device 10 transmits latitude/longitude/height of each point of this position information 123 to the conversion information storing device 14 described above one piece thereof each time and converts them into a unique identifier.

In FIG. 13C, the position information 123 described above is converted into a unique identifier one piece thereof at each time, and position space information 124 representing a space range defined by the unique identifier using a rectangular frame is illustrated. By converting the position information described above into a unique identifier, the position space information 124 can be acquired.

In accordance with this, a route represented by the route information 120 described above is converted into continuous position space information 124 and is represented. In addition, information relating to a type of object that can be present in or enter the range of the space described above and time is associated with each piece of the position space information 124. This continuous position space information 124 will be referred to as format route information in this embodiment.

Referring back to FIG. 9, continuation of the process performed by the autonomous mobility control system will be described again. After Step S214, the system control device 10 downloads the above-described space information associated with each unique identifier of the format route information described above from the conversion information storing device 14 in Step S215.

Then, in Step S216, the system control device 10 converts the space information described above into a format for being able to be reflected in the three-dimensional map of the above-described cyber space of the autonomous mobility 12, thereby generating information (hereinafter, it will be referred to as a cost map) representing positions of a plurality of objects (obstacles) inside of a predetermined space. The cost map may be initially generated for a space of all the routes of the format route information described above or may be generated using a method in which the cost map is generated in a form being separated in a predetermined area and is sequentially updated.

Next, the system control device 10 stores the format route information described above and the cost map described above in association with a unique identification number assigned to the autonomous mobility 12 in Step S217. The autonomous mobility 12 monitors (hereinafter, it will be referred to as polling) its own unique identification number described above through a network with a predetermined time interval and downloads the associated cost map in Step S218.

The autonomous mobility 12 reflects the latitude/longitude information of each unique identifier of the format route information described above in the three-dimensional map of the cyber space generated thereby as route information in Step S219.

Next, the autonomous mobility 12 reflects the cost map described above in the three-dimensional map of the cyber space as obstacle information on the route in Step S220. In a case in which the cost map described above is generated in the form of being separated with a predetermined gap, after moving from an area for which the cost map described above has been generated, the autonomous mobility 12 downloads a cost map of a next area and updates the cost map.

In Step S221, the autonomous mobility 12 moves in accordance with the route information while avoiding objects (obstacles) input in the cost map. In other words, movement control is performed on the basis of the cost map. At this time, in Step S222, the autonomous mobility 12 moves while performing object detection, and, when there a difference from the cost map described above, it moves while updating the cost map using the object detection information.

In addition, in Step S223, the autonomous mobility 12 transmits information of the difference from the cost map to the system control device 10 together with a corresponding unique identifier. The system control device 10 that has acquired the unique identifier and the information of the difference from the cost map transmits space information to the conversion information storing device 14 in Step S224 illustrated in FIG. 10, and the conversion information storing device 14 updates the space information of the corresponding unique identifier in Step S225.

Here, details of the space information to be updated do not directly reflect the information of a difference from the cost map but is transmitted to the conversion information storing device 14 after being abstracted by the system control device 10. Details of the abstraction described above will be described below.

Every time passing through a divided space associated with each unique identifier, the autonomous mobility 12 moving on the basis of the format route information described above transmits a unique identifier associated with the space through which it is currently passing to the system control device 10 in Step S226.

Alternatively, at the time of polling described above, the autonomous mobility 12 may associate the space with its own unique identification number described above. The system control device 10 perceives the current position of the autonomous mobility 12 on the format route information on the basis of the unique identifier of the space that has been received from the autonomous mobility 12.

By repeating Step S226 described above, the system control device 10 can perceive a position at which the autonomous mobility 12 is currently located in the format route information described above. In addition, the system control device 10 may stop to store a unique identifier of a space through which the autonomous mobility 12 has passed, and in accordance with this, a storage data capacity of the format route information described above can be reduced as well.

In Step S227, the system control device 10 generates the checking screen 50 and the map display screen 60 described with reference to FIGS. 2 and 3 on the basis of the perceived current position information of the autonomous mobility 12 and displays the screens on the display screen of the web page. Every time the above-describe unique identifier representing the current position is transmitted to the system control device 10 by the autonomous mobility 12, the system control device 10 updates the checking screen 50 and the map display screen 60 described above.

On the other hand, in Step S228, together with storing detection information of a detection range, the sensor node 15 abstracts the above-described detection information in Step S229 and transmits resultant information to the conversion information storing device 14 as the above-described space information in Step S230. The abstraction, for example, is information indicating whether or not an object is present and indicating whether or not there has been a change in the presence state of an object and is not detailed information relating to an object.

Detailed information relating to an object is stored in a memory inside of the sensor node. Then, in Step S231, the conversion information storing device 14 stores the above-described space information that is abstracted detection information in association with a unique identifier of a position corresponding to the space information. In accordance with this, the space information described above is stored in one unique identifier inside of the format database.

In addition, in a case in which an external system different from the sensor node 15 uses the space information described above, the external system acquires the above-described detection information inside of the sensor node 15 through the conversion information storing device 14 on the basis of the above-described space information inside of the conversion information storing device 14 and uses the detection information. At this time, the conversion information storing device 14 also has a function of connecting communication specifications of the external system and the sensor node 15.

By performing storage of the space information as described above between a plurality of devices not limited to the sensor node 15, the conversion information storing device 14 has a function of connecting data of a plurality of devices with a data amount that is a relatively small amount. In addition, in Steps S215 and S216, in a case in which the system control device 10 needs detailed object information at the time of generating a cost map, detailed information may be downloaded from an external system storing detailed detection information of space information.

Here, it is assumed that the sensor node 15 has updated the space information described above on a route of the above-described format route information of the autonomous mobility 12. At this time, the sensor node 15 acquires the above-described detection information in Step S232, generates space information abstracted in Step S233, and transmits the space information to the conversion information storing device 14 in Step S234. The conversion information storing device 14 stores the space information described above in the format database 14-4 in Step S235.

The system control device 10 checks a change of the above-described space information in the managed format route information described above with a predetermined time interval and downloads space information in Step S236 when there is a change.

Then, a cost map associated with a unique identification number assigned to the autonomous mobility 12 is updated in Step S237. The autonomous mobility 12 recognizes update of a cost map using polling and reflects the update in the three-dimensional map of the cyber space generated thereby in Step S238.

As described above, by using space information shared among a plurality of devices, the autonomous mobility 12 can recognize a change on the route, which cannot be recognized thereby without using the space information, in advance and can respond to the change. In a case in which the series of systems described above are performed, and the autonomous mobility 12 arrives at the destination place in Step S239, a unique identifier is transmitted in Step S240.

In accordance with this, the system control device 10 that has recognized the unique identifier displays an arrival display in the user interface 11 and ends the application in Step S241.

According to this embodiment, as described above, the format of the digital architecture and an autonomous mobility control system using the format can be provided.

As described with reference to FIGS. 11A, 11B, and 12, information (space information) relating to a type of an object that is present in or can enter the range of the space 100 and time is stored in a time series of the past to the future in the format database 14-4 described above. In addition, the space information described above is updated on the basis of information input from an external sensor or the like connected to the conversion information storing device 14 to be able to communicate therewith and is shared to other external systems that can be connected to the conversion information storing device 14.

As one kind of such space information, there is type information of an object inside the space. Here, the type information of an object inside the space, for example, is information that can be acquired from map information such as a roadway, a sideway, a bike lane, or the like on a road. In addition, information of a direction of movement of a mobility on a roadway, traffic regulations, and the like other than that described above can be defined as type information in this way. Furthermore, as described below, type information can be defined in a space itself as well.

### Second Embodiment

In this embodiment, in addition to the first embodiment, a method of freely setting a reference position of the format and a coordinate system in the configuration example of the format described above with reference to FIGS. 11A, 11B, and 12 will be subsequently described.

In items of the configuration of the format described above, the format has been described as a format in which the space of the Earth is divided into divided spaces determined using ranges having latitude/longitude/height as position references, and a unique identifier is added to each of the spaces such that the spaces can be managed.

In addition, it has been described that the position references defining the space may be defined using position information representing a position on the Earth other than the latitude/longitude/height such as a military grid reference system (MGRS).

A time space format is targeted such that a space of the world can be uniquely identified by recognizing a unique identifier, and position information and space information are shared with other devices using unique identifiers. For this reason, it is preferable that the time space format is built on the basis of a common position reference in the world.

However, even for the latitude/longitude that are rules representing a position on the Earth of the current state, separately from the world geodetic system, each country tends to employ a different geodetic system, and also for the time space format, an optimal reference setting is predicted to be performed in each region.

In addition, inside a structure such as a building, it is the most efficient to set references matching features such as a shape of the building, a height of each floor, and the like for expressing a space, and references different from the references uniformized in the world and references set in each region are considered to be set.

Thus, even in a space in which time space formats of various references are defined in the world, in order to enable various devices to appropriately share position information and space information, a relationship between time space formats set in respect references needs to be defined.

In this embodiment, hereinafter, a reference of a time space format defined by setting reference parameters will be referred to as a “reference system”. The reference parameters will be described below. In addition, it is assumed that “world reference system” defined as a uniform reference system in the world, “local reference system” defined in each region such as each country or each prefecture, and a reference system called “indoor reference system” defined at an indoor place such as the inside of a building or a tunnel are present, and a relationship thereof will be described.

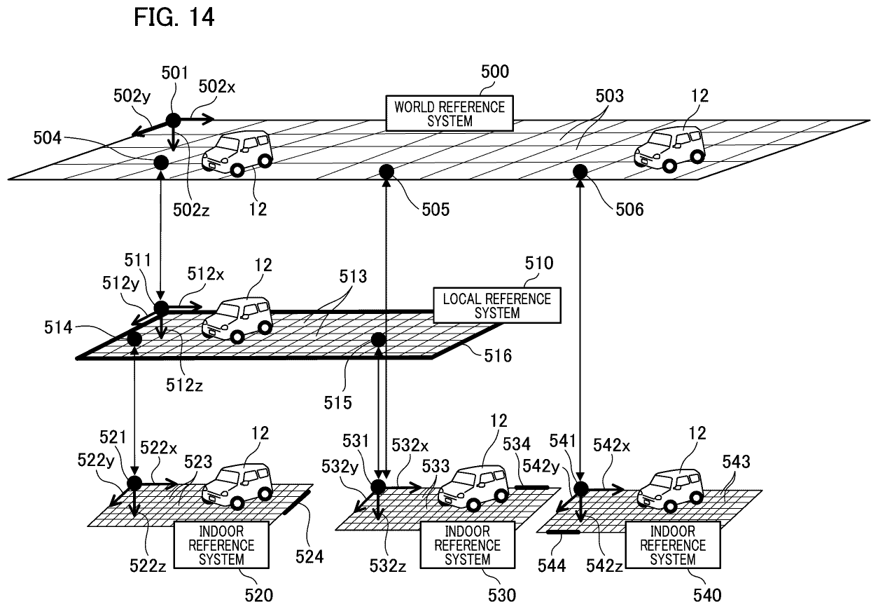

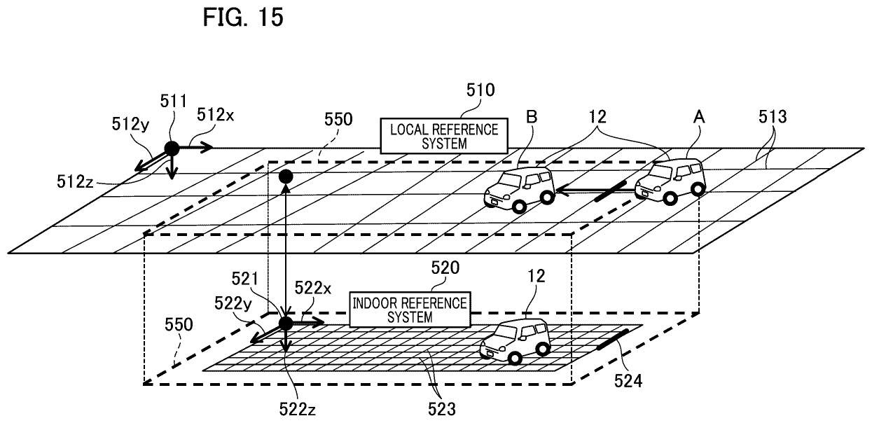

The relation of “world reference system”, “local reference system”, and “indoor reference system” will be described with reference to FIGS. 14 and 15. FIG. 14 is a diagram illustrating each reference system as a hierarchical structure. FIG. 15 is a diagram illustrating a hierarchical structure representing a relationship between a local reference system 510 and an indoor reference system 520 illustrated in FIG. 14 in detail.

First, reference system structures and reference parameters of a world reference system 500, the local reference system 510, and indoor reference systems 520, 530, and 540 will be described with reference to FIG. 14.

First, the world reference system 500 will be described. The world reference system 500 is an outdoor world reference system built using reference parameters and is a coordinate system having coordinates axes 502x, 502y, and 502z of three axes, which have an origin 501 as its origin, as coordinate axes. Although the world reference system 500 is displayed on a plane for easy understanding in FIG. 14, it actually is a three-dimensional coordinate system having a height axis in the direction of a coordinate axis 502z.

Grids 503 are grids defined to be in parallel with the coordinate axes 502x and 502y and be equally spaced in the world reference system 500. The grids 503 are disposed also in the direction of the coordinate axis 502z and defines a space division position in the height direction. Spaces divided in accordance with these grids 503 are defined as division spaces that are divided and managed using the time space format.

A unique identifier is assigned to a divided space using a predetermined rule for a reference position (here, the center of the divided space). The autonomous mobility control system can uniquely identify each of divided spaces divided by the grids 503 inside of the world reference system 500 using a unique identifier.

In this embodiment, as the predetermined rule for assigning unique identifiers, for example, an assignment rule such as Morton's Order can be used. In this embodiment, the predetermined rule for assigning unique identifiers is not limited thereto but may be a rule for aligning and assigning unique identifiers in order from an arbitrary reference or the like. Similar to the space 100 described with reference to FIG. 11, a reference position of a divided space may not be the center of the divided space, and, for example, a corner of the space or the center of the bottom face thereof may be set as the reference position.

In this embodiment, the world reference system 500 is an outdoor reference system. For this reason, in a case in which the autonomous mobility 12 moves using the world reference system 500, the autonomous mobility 12 can recognize its own position mainly by acquiring GPS information.

However, this embodiment is not limited to this embodiment, and the autonomous mobility 12 may acquire its own position using another method. The autonomous mobility 12 may use a technique of recognizing its own position, for example, by detecting a relative distance between a landmark (distinctive object) and itself.

In this case, the landmark has position information associated with a divided space of the world reference system. The autonomous mobility 12 detects a relative distance between the landmark and itself using a distance measuring function mounted therein in a real space. The autonomous mobility 12 may use another self-position estimating method.

The position of the origin 501, the setting specification of the coordinate axes 502x, 502y, and 502z, the assignment rule of unique identifiers, the reference position of a divided space, the method for estimating a self-position, and the like described above are reference parameters of the world reference system 500.

In addition, in the case of a coordinate system in which the coordinate axes 502x, 502y, and 502z are set to intersect at the origin 501 at right angles, a divided space is a rectangular parallelepiped. However, depending on the origin 501 and the axis setting of the coordinate axes 502x, 502y, and 502z, there is also a possibility of the shape of the divided space, for example, being a different shape such as a parallelepiped. In that case, a parameter for setting the shape of the divided space may be added as a setting parameter of the reference system.

A coordinate point 504 represents a position of an origin 511 of the local reference system to be described below on the world reference system. A coordinate point 505 represents a position of an origin 531 of the indoor reference system on the world reference system. A coordinate point 506 represents a position of an origin 541 of the indoor reference system on the world reference system.

Subsequently, the local reference system 510 will be described. In description of the local reference system 510, description of parts that are duplicate of description details of the world reference system 500 will be omitted. The local reference system 510 is an outdoor local reference system built using reference parameters and is a coordinate system having coordinate axes 512x, 512y, and 512z of three axes, which have an origin 511 as its origin, as coordinate axes.

Grids 513 are grids defined to be in parallel with the coordinate axes 512x and 512y and be equally spaced in the local reference system 510. The grids 513 are disposed also in the direction of the coordinate axis 512z and defines a space division position in the height direction. Spaces divided in accordance with these grids 513 are defined as division spaces that are divided and managed using the time space format.

A unique identifier is assigned to a divided space using a predetermined rule for a reference position (here, the center of the divided space). The autonomous mobility control system can uniquely identify each of divided spaces divided by the grids 513 inside of the local reference system 510 using a unique identifier.

In this embodiment, similar to the world reference system 500, the local reference system 510 is an outdoor reference system. For this reason, in a case in which the autonomous mobility 12 moves using the local reference system 510, the autonomous mobility 12 can recognize a self-position mainly by acquiring GPS information, and, similar to the world reference system 500, another self-position estimating method may be used.

A boundary part 516 denoted by a thick line represents a boundary part between the world reference system 500 and the local reference system 510. Since the local reference system 510 is an outdoor system, the boundary part 516 is an outer periphery of an area occupied by the local reference system 510.

The position of the origin 511, the setting specification of the coordinate axes 512x, 512y, and 512z, the assignment rule of unique identifiers, the reference position of a divided space, the method for estimating a self-position, the position and the range of the boundary part 516, and the like described above are reference parameters of the local reference system 510.

In addition, there is also a possibility of the shape of the divided space being a different shape also in the local reference system 510, and a parameter for setting the shape of the divided space may be added as a setting parameter of the reference system.

A coordinate point 514 represents a position of an origin 521 of the indoor reference system to be described below on the local reference system 510. A coordinate point 515 represents a position of an origin 531 of the indoor reference system on the local reference system 510.

Subsequently, the indoor reference systems 520, 530, and 540 will be described. In description of the indoor reference systems 520, 530, and 540, description of parts that are duplicate of description details of the world reference system 500 will be omitted. The indoor reference systems 520, 530, and 540 are indoor reference systems built at indoor places using reference parameters.

The indoor reference system 520 is a coordinate system having coordinate axes 522x, 522y, and 522z of three axes, which have an origin 521 as its origin, as coordinate axes. The indoor reference system 530 is a coordinate system having coordinate axes 532x, 532y, and 532z of three axes, which have an origin 531 as its origin, as coordinate axes. The indoor reference system 540 is a coordinate system having coordinate axes 542x, 542y, and 542z of three axes, which have an origin 541 as its origin, as coordinate axes.

Grids 523 are grids defined to be in parallel with the coordinate axes 522x and 522y and be equally spaced in the indoor reference system 520. The grids 523 are disposed also in the direction of the coordinate axis 522z and defines a space division position in the height direction. Spaces divided in accordance with these grids 523 are defined as division spaces that are divided and managed using the time space format.

Grids 533 are grids defined to be in parallel with the coordinate axes 532x and 532y and be equally spaced in the indoor reference system 530. The grids 533 are disposed also in the direction of the coordinate axis 532z and defines a space division position in the height direction. Spaces divided in accordance with these grids 533 are defined as division spaces that are divided and managed using the time space format.

Grids 543 are grids defined to be in parallel with the coordinate axes 542x and 542y and be equally spaced in the indoor reference system 540. The grids 543 are disposed also in the direction of the coordinate axis 542z and defines a space division position in the height direction. Spaces divided in accordance with these grids 543 are defined as division spaces that are divided and managed using the time space format.

A unique identifier is assigned to a divided space using a predetermined rule for a reference position (here, the center of the divided space). The autonomous mobility control system can uniquely identify each of divided spaces divided by the grids 523, the grids 533, and the grids 543 inside of the indoor reference system 520, the indoor reference system 530, and the indoor reference system 540 in each reference system using a unique identifier.

In this embodiment, the indoor reference system 520, the indoor reference system 530, and the indoor reference system 540 are indoor reference systems. For this reason, in a case in which the autonomous mobility 12 moves using the indoor reference system 520, the indoor reference system 530, or the indoor reference system 540, the autonomous mobility 12 can recognize a self-position mainly using a self-position estimating method defined in the indoor reference system.

As an indoor self-position estimating method, the above-described method using a landmark and a technique of estimating a position from calculation of an amount of movement using odometry are considered, and any one method thereof may be used.

A boundary part 524 denoted by a thick line represents a boundary part between the world reference system 500 or the local reference system 510 and the indoor reference system 520. A boundary part 534 denoted by a thick line represents a boundary part between the world reference system 500 or the local reference system 510 and the indoor reference system 530.

A boundary part 544 denoted by a thick line represents a boundary part between the world reference system 500 or the local reference system 510 and the indoor reference system 540. In this embodiment, all the indoor reference system 520, the indoor reference system 530, and the indoor reference system 540 are indoor systems, and thus the boundary parts 524, 534, and 544 are access parts (entrances or the like) for the indoor reference system 520, the indoor reference system 530, and the indoor reference system 540.

The position of the origin 521, the setting specification of the coordinate axes 522x, 522y, and 522z, the assignment rule of unique identifiers, the reference position of a divided space, the method for estimating a self-position, the position and the range of the boundary part 524, and the like described above are reference parameters of the indoor reference system 520.

The position of the origin 531, the setting specification of the coordinate axes 532x, 532y, and 532z, the assignment rule of unique identifiers, the reference position of a divided space, the method for estimating a self-position, the position and the range of the boundary part 534, and the like described above are reference parameters of the indoor reference system 530.

The position of the origin 541, the setting specification of the coordinate axes 542x, 542y, and 542z, the assignment rule of unique identifiers, the reference position of a divided space, the method for estimating a self-position, the position and the range of the boundary part 544, and the like described above are reference parameters of the indoor reference system 540.

Hereinafter, a relationship between the reference systems will be described with reference to FIGS. 14 and 15. In FIGS. 14 and 15, duplicate description will be omitted. In FIG. 15, a reference system setting area 550 denoted by a dotted-line range is an area representing a space larger than a space occupied by the indoor reference system 520 by a predetermined amount. Details of the reference system setting area 550 will be described below.

In FIG. 14, as described above, the coordinate point 504 of the world reference system 500 represents a position of the origin 511 of the local reference system 510 on the world reference system 500. This represents that the presence of the local reference system 510 is registered in the world reference system 500, and the reference parameters of the local reference system 510 including the origin 511 are registered in the world reference system 500.

The registration described here represents that the presence of the local reference system 510 and the reference parameters of the local reference system 510 including the origin 511 are associated with a unique identifier of the world reference system 500 as space information.

Similarly, it is represented that the indoor reference system 520 and the indoor reference system 530 are registered in the local reference system 510, and the indoor reference system 530 and the indoor reference system 540 are registered in the world reference system 500.

The autonomous mobility control system according to this embodiment has a structure in which the local reference systems are respectively registered in a hierarchical structure such that the local reference system 510 is registered in the world reference system 500, and the indoor reference system 520 is registered in the local reference system 510.

In addition, the autonomous mobility control system according to this embodiment has a structure in which the local reference system 510 and the indoor reference system 530 can be registered in the world reference system 500.

Furthermore, the autonomous mobility control system according to this embodiment has a structure in which a lower layer of the local reference system 510 such as the indoor reference system 540 can be directly registered in the world reference system 500 not through the local reference system 510.

As above, in the autonomous mobility control system, a relationship of various reference systems is considered. The autonomous mobility control system according to this embodiment has a hierarchical structure in which the world reference system 500 is set as a highest-rank reference system, and the local reference system 510 or the indoor reference systems 520, 530, and 540 are associated as reference systems of a lower rank of the world reference system 500.

In addition, as described above, the world reference system 500 is built, for example, using reference parameters such as latitude/longitude of a world geodetic system as a highest-rank reference system that are common in the world.

The local reference system 510 is built using arbitrary reference parameters that are set for being used only in each region, for example, such as latitude/longitude and the like of a geodetic system defined by each country and is a reference system having a higher-rank reference system.

For example, in the case of the local reference system 510, a higher-rank reference system is the world reference system 500 in which the local reference system 510 itself and the indoor reference system 540 are registered. In other words, the higher-rank reference system represents a reference system in which the own reference system and at least one other reference system are registered.

Thus, for example, in a case in which there is another local reference system X (not illustrated) in which the local reference system 510 and another reference system are registered, the local reference system 510 may be referred to as a local reference system having the local reference system X as a higher-rank reference system.

In addition, the local reference system is not limited to a higher-rank reference system and may be directly registered in position information such as latitude/longitude or a military grid reference system (MGRS). As above, the local reference system can be arbitrarily set by a setter thereof.

Furthermore, as described above, the local reference system 510 registers its reference parameters in the world reference system 500 that is a higher-rank reference system and registers the reference parameters of the world reference system 500 as space information.

The reference parameters of the local reference system 510 are registered in a divided space of a range of a reference system setting area (not illustrated) that is larger than a divided space of a range to which the local reference system 510 corresponds in the world reference system 500 by a predetermined amount as space information.

Regarding details of the reference system setting area, although it will be described as a reference system setting area 550 of the indoor reference system 520 illustrated in FIG. 15, it is assumed that the reference system setting area is similarly set also in the local reference system 510.

The reference parameters of the world reference system 500 are registered in all the divided spaces of the local reference system 510 or divided spaces present in the vicinity of the boundary part 516 as space information. In accordance with this, an autonomous mobility going to move to the local reference system 510 while moving in the world reference system 500 can recognize presence of the local reference system 510 from the space information of the reference system setting area.

By recognizing the presence of the local reference system 510, the autonomous mobility can smoothly move from the world reference system 500 to the local reference system 510.

In addition, an autonomous mobility going to move to the world reference system 500 while moving in the local reference system 510 acquires the reference parameters of the world reference system 500 from the space information of the local reference system 510 when approaching the boundary part 516. In accordance with this, the autonomous mobility can smoothly move from the local reference system 510 to the world reference system 500. In addition, a specific movement method of a case in which the autonomous mobility crosses over different reference systems will be described below.

Although the indoor reference system will be described with reference to FIG. 15 using the indoor reference system 520 as a representative example, the indoor reference systems 530 and 540 that are other indoor reference systems also have a similar relationship.

The indoor reference system 520, for example, is built using arbitrary reference parameters that are set for being used only inside of each structure (each building or the like) and is a reference system having a higher-rank reference system. Thus, similar to the local reference system, the reference parameters can be arbitrarily by a setter, and a difference from those of the local reference system is that the reference parameters are mainly used for indoor reference system setting.

In other words, the indoor reference system has the same meaning as a local reference system set for being used dedicatedly at an indoor place, and although the setting as “indoor reference system” is not essential, for easy understanding, it will be described as “indoor reference system” in this embodiment.

Similar to the local reference system, the indoor reference system 520 registers its reference parameters in the local reference system 510 that is a higher reference system and registers the reference parameters of the local reference system 510 as space information.

The reference parameters of the indoor reference system 520 are registered in a divided space of a range of a reference system setting area 550 that is larger than a divided space of a range to which the indoor reference system 520 corresponds in the local reference system 510 by a predetermined amount as space information. The reference parameters of the local reference system 510 are registered in all the divided spaces of the indoor reference system 520 or divided spaces present in the vicinity of the boundary part 524 as space information.

In accordance with this, an autonomous mobility going to move to the indoor reference system 520 while moving in the local reference system 510 can recognize presence of the indoor reference system 520 from the space information of the reference system setting area 550. By recognizing the presence of the indoor reference system 520, the autonomous mobility can smoothly move from the local reference system 510 to the indoor reference system 520.

In addition, an autonomous mobility going to move to the local reference system 510 while moving in the indoor reference system 520 acquires the reference parameters of the local reference system 510 from the space information of the indoor reference system 520 when approaching the boundary part 524.

In accordance with this, the autonomous mobility can smoothly move from the indoor reference system 520 to the local reference system 510. In addition, similar to the description presented above, a specific movement method of a case in which the autonomous mobility crosses over different reference systems will be described below. As above, each reference system is built in a hierarchical structure, and

reference systems associated in the hierarchical structure have mutual reference parameters. In addition, the registration method of the reference parameters described above is one example. For example, another registration method such as a method in which reference parameters of all the reference systems are aggregated in a predetermined DB or the like that integrally manages the highest-rank reference system and the reference systems, and each reference system registers only the reference parameters of the highest-rank reference system may be used.

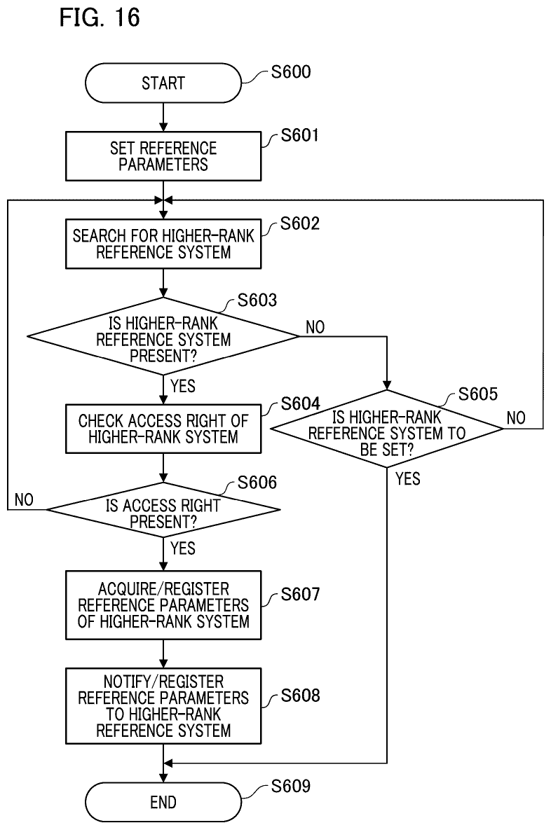

Here, a specific process from generation to registration of a local reference system and an indoor reference system will be described with reference to FIGS. 15 and 16. FIG. 16 is a flowchart illustrating processes from generation to registration of a reference system.

In description, the indoor reference system 520 illustrated in FIG. 15 will be described as a specific example. As described above, a format including information of a unique identifier of each reference system is managed using the format database 14-4 of the conversion information storing device 14. The process illustrated in FIG. 16 is performed by the control unit 14-3 of the conversion information storing device 14.

In Step S600, the control unit 14-3 starts the process. In Step S601, the control unit 14-3 sets reference parameters for an indoor reference system 520 to be newly registered. More specifically, a setter newly setting the indoor reference system 520 inputs parameters for the indoor reference system 520 by operating the user interface 11.

The setter, for example, is a building owner. The system control device 10 receives parameters input using the user interface 11 from the user interface 11. The system control device 10 transmits the parameters received from the user interface 11 to the conversion information storing device 14.

The control unit 14-3 of the conversion information storing device 14 sets the parameters that have been received from the system control device 10. As settings of the indoor reference system 520, a position of the origin 521, axial directions of the coordinate axes 522x, 522y, and 522z, a size of a divided space, a reference position of a divided space, and the like are set. In addition, as settings of the indoor reference system 520, an assignment rule for unique identifiers, a method of estimating a self-position, a position and a size of the boundary part 524, a range of the reference system setting area 550, and the like are set.

Subsequently, the control unit 14-3 searches for a higher-rank reference system in which the indoor reference system 520 is to be registered in Step S602. More specifically, the control unit 14-3 searches for a higher-rank reference system of the indoor reference system 520 of which the reference parameters have been set in Step S601.

The control unit 14-3 searches for a method of acquiring space information of an area, for example, to which the indoor reference system 520 of the world reference system 500 corresponds and presence/absence of the reference system information associated with the latitude/longitude, for example, using the Internet or the like.

A search target at this time is not limited to a database or the like connected to the Internet and may be any database or the like in which the reference system information is managed. In addition, for the search of a higher-rank reference system, a method in which a setter performs searching by operating a device other than the autonomous mobility control system and inputs a result of the search to the autonomous mobility control system may be employed.

In Step S603, the control unit 14-3 judges presence/absence of a higher-rank reference system. In a case in which the control unit 14-3 judges absence of a higher-rank reference system, the process of Step S605 is performed. In Step S605, the control unit 14-3 judges whether or not setting of the higher-rank reference system is to be performed. More specifically, for example, the autonomous mobility control system inquires the setter about whether or not the setting of the higher-rank reference system is to be performed through the user interface 11.

In a case in which a setter's input to the user interface 11 as a response to the inquiry about whether setting of the higher-rank reference system is to be performed is an input indicating that the higher-rank reference system is to be set, the control unit 14-3 causes the process to proceed to Step S609 after setting the higher-rank reference system and ends the process.

When the world reference system 500 and the local reference system 510 are not present as a setting of a higher-rank refence system, a setter can newly set a local reference system as a higher-rank reference system or register the indoor reference system 520 as a higher-rank reference system.

In a case in which a setter's input to the user interface 11 as a response to the inquiry about whether setting of the higher-rank reference system is to be performed is an input indicating that the higher-rank reference system is not to be set, the control unit 14-3 performs the process of Step S602. In other words, in a case in which a setter does not desire to newly set the local reference system or does not desire to set the indoor reference system 520 as a higher-rank reference system, a search for a higher-rank reference system is performed again using another means.

Hereinafter, description of a case in which it is judged that the world reference system 500 and the local reference system 510 are present as higher-rank reference systems of the indoor reference system 520 in Step S603 will be continued.

In Step S603, in a case in which the control unit 14-3 judges presence of a higher-rank reference system, the process of Step S604 is performed. For example, in Step S603, in a case in which the control unit 14-3 has found reference parameters of the local reference system 510 in the space information of the world reference system 500 of an area to which the indoor reference system 520 corresponds, the process of Step S604 is performed.

In Step S604, the control unit 14-3 checks a setter's access right for the corresponding higher-rank reference system. More specifically, here, it is checked whether or not the setter satisfies the access right for the local reference system 510.

The access right for a reference system, for example, permits registration of the reference system, sharing of reference parameters, provision of space information, and the like only in a case in which a setter Y different from the setter who has set the corresponding reference system has a predetermined qualification. As the predetermined qualification, for example, there is a qualification of the setter Y being a person relating to an operating company or the like.

In Step S604, the control unit 14-3 judges whether or not the setter satisfies the access right for the corresponding to the higher-rank reference system. In a case in which it is judged that the setter does not satisfy the access right, the process of Step S602 is performed, and the control unit 14-3 searches for another higher-rank reference system again. In a case in which it is judged that the setter satisfies the access right, the control unit 14-3 performs the process of Step S607.

In Step S607, the control unit 14-3 acquires reference parameters of the local reference system 510 that is a higher reference system and registers the reference parameters of the local reference system 510 as the higher-rank reference system in the space information of all the divided spaces of the indoor reference system 520.

This process is one example of an association process (an association unit) associating, for example, the local reference system 510 as a second reference system with the indoor reference system 520 as a first reference system. As described above, the first reference system and the second reference system include at least one of a coordinate system defined using latitude/longitude/height, an arbitrary XYZ coordinate system, an MGRS, a pixel coordinate system, and a tile coordinate system.

In Step S608, the control unit 14-3 notifies the local reference system 510 that is a higher-rank reference system of the reference parameters of the indoor reference system 520. In addition, in Step S608, the control unit 14-3 registers the reference parameters of the indoor reference system 520 as a lower-rank reference system in the space information of all the divided spaces of the local reference system 510. This process is one example of an association unit associating the indoor reference system 520 with the local reference system 510.

Although an access right for each reference system may not be set, in a case in which an access right is to be set, the access right may be set in the process of Step S607 or Step S608. After Step S608, the process proceeds to Step S609, and the process ends.

In the description presented above, although the process of newly registering the indoor reference system has been described as a specific example, in this embodiment, a similar process is performed also in a case in which the local reference system is set, and registration of the reference system is performed. As above, according to this embodiment, a local reference system or an indoor reference system can be newly registered.

In addition, although the process described above is a process in which the control unit 14-3 as a subject registers a new reference system, the present invention is not limited thereto, and another control unit such as the control unit 10-2 of the system control device 10 may serves as a subject. Furthermore, each process may be performed by the setter as a subject like a case in which the setter as a subject performs a search for a higher-rank reference system using another system, inputs a result of the search to the autonomous mobility control system according to this embodiment or the like.

The autonomous mobility control system according to this embodiment may use a technique in which, for example, a higher-rank reference system automatically detects a local reference system or an indoor reference system set inside an area to which the autonomous mobility control system corresponds and instantly registers the detected reference system.

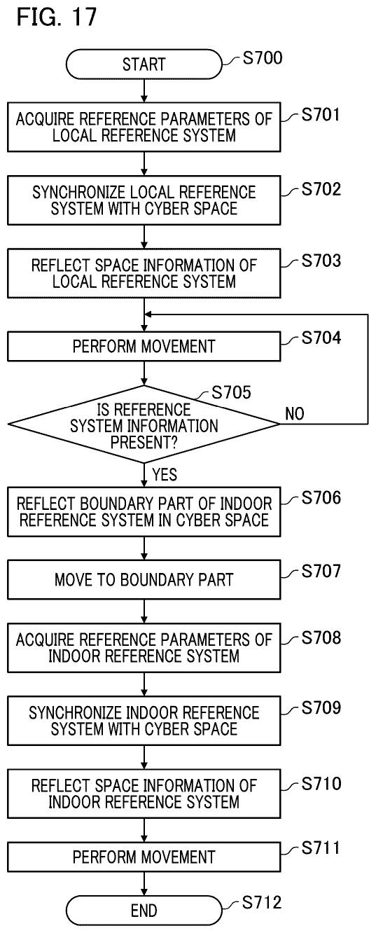

Next, an operation performed when an autonomous mobility moves using a reference system and an operation performed when movement crossing over a plurality of reference systems will be described with reference to FIGS. 15 and 17. FIG. 17 is a flowchart illustrating an operation of an autonomous mobility performing movement crossing over a plurality of reference systems.

First, a method of movement of the autonomous mobility using a reference system will be described with reference to FIG. 15. In FIG. 15, it is assumed in description that the current position of the autonomous mobility 12 is a place A and is moving.

When the autonomous mobility 12 is traveling at the place A of the local reference system 510, the coordinate system of the autonomous mobility 12 is defined using the origin 511 and the coordinate axes 512x, 512y, and 512z. By synchronizing the local reference system 510 of which a size and a position of a space are defined using a grid 513 with its own cyber space described above with reference to FIG. 4 and the like, the autonomous mobility 12 can use the space information of the local reference system 510.

Here, the method of synchronizing the local reference system 510 and the cyber space of the autonomous mobility 12 and the method of utilizing the space information will be described with reference to FIG. 5.

As described above with reference to FIG. 4 and the like, the autonomous mobility 12 has an arbitrary XYZ coordinate system space having P0 as its origin. From this, the autonomous mobility 12 sets the origin 511 of the local reference system 510 as P0 and builds its own arbitrary XYZ coordinates on the basis of the coordinate axes 512x, 512y, and 512z of the local reference system 510. In this way, the autonomous mobility 12 can synchronize the local reference system 510 with the cyber space of the autonomous mobility 12.

Furthermore, by using the assignment rule for unique identifiers set as the reference parameters of the local reference system 510, the autonomous mobility 12 can identify a space corresponding to an arbitrary unique identifier and a position thereof. In addition, the autonomous mobility 12 can associate space information associated with a unique identifier in advance and a space inside of its own cyber space and a position thereof with each other.

Thus, for example, in a case in which ground object information is associated with an arbitrary unique identifier as space information, the autonomous mobility 12 can reflect the ground object information in its own cyber space and perform movement of avoiding the recognized ground object. As above, the autonomous mobility 12 can move using the local reference system 510.

Next, an operation performed when the autonomous mobility crosses over a reference system will be described with reference to FIGS. 15 and 17. In FIG. 15, it is assumed in description that the autonomous mobility 12 moves from a place A (an area of the local reference system 510) to a place B (an area of the indoor reference system 520).

In Step S700, the autonomous mobility 12 starts the process. In Step S701, the autonomous mobility 12 acquires reference parameters of the local reference system 510 at the place A illustrated in FIG. 15.

In Step S702, the autonomous mobility 12 synchronizes the local reference system 510 with its own cyber space using the method described above.

In Step S703, the autonomous mobility 12 reflects space information (for example, ground object information or the like) associated with a divided space of the local reference system 510 in its own cyber space.

In Step S704, the autonomous mobility 12 performs self-position estimation (for example, GPS information is used) and reflects the estimated self-position in the cyber space, thereby autonomously moving while avoiding obstacles represented by ground object information reflected in the cyber space.

In Step S705, the autonomous mobility 12, at the time of movement, moves while searching whether or not reference system information is present in the space information of the direction of movement in which it moves. In a case in which the autonomous mobility 12 judges that reference system information is absent in the space information of the direction of movement, the process of Step S704 is performed, and the autonomous mobility 12 continues to move. In a case in which the autonomous mobility 12 judges that reference system information is present in the space information of the direction of movement, the process of Step S706 is performed.

Here, it is assumed that the autonomous mobility 12 has moved to the reference system setting area 550 illustrated in FIG. 15. In this case, the autonomous mobility 12 judges that reference system information of the indoor reference system 520 is present in the space information of the direction of movement, and the process of Step S706 is performed.

At this time, in Step S705, the autonomous mobility 12 detects that the reference system information of the indoor reference system 520 is present in the space information of the local reference system 510. In accordance with this, the autonomous mobility 12 recognizes the presence of the indoor reference system 520.

In Step S706, the autonomous mobility 12 reflects information of a position and a size of the boundary part 524 set as the reference parameters of the indoor reference system 520 in its own cyber space. In accordance with this, the autonomous mobility 12 can recognize an entrance for movement into the inside of the indoor reference system 520. Thereafter, in Step S707, the autonomous mobility 12 moves to the boundary part 524.

In Step S708, the autonomous mobility 12 acquires reference parameters other than the boundary part 524 such as an origin and coordinate axes of the indoor reference system 520 at the boundary part 524. In Step S709, the autonomous mobility 12 synchronizes the indoor reference system 520 with its own cyber space using the method described above. In Step S710, the autonomous mobility 12 reflects space information (for example, ground object information or the like) associated with the divided space of the indoor reference system 520 in its own cyber space.

In Step S711, the autonomous mobility 12 performs self-position estimation (for example, using a self-position estimating unit using an indoor landmark or the like), reflects the self-position in the cyber space, and autonomously moves while avoiding obstacles represented by the ground object information reflected in the cyber space.

In accordance with the operations described above, the autonomous mobility 12 can move from the place A (the area of the local reference system 510) to the place B (the area of the indoor reference system 520). In addition, to the contrary, in the case of movement from the place B (the area of the indoor reference system 520) to the place A (the area of the local reference system 510), similar to the operations described above, the autonomous mobility 12 may synchronize the local reference system 510 with its own cyber space at the boundary part 524.

According to the second embodiment described above, a setter can arbitrarily set the reference system. In addition, according to the second embodiment, also in a space in which time space formats of various reference systems in the world are set, various devices appropriately share position information and space information, and movement that is appropriate for each position space can be performed.

As described above, according to each embodiment of the present invention, a format of a digital architecture and an autonomous mobility control system using this are more efficiently provided also in consideration of safety.

In addition, in each embodiment described above, an example in which a control system is applied to an autonomous mobility has been described. However, the mobile object according to the present invention is not limited to autonomous mobilities such as an automated guided vehicle (AGV) and an autonomous mobile robot (AMR).

For example, the autonomous mobility may be any device as long as it is a mobile device that moves such as a vehicle, a train, a ship, an airplane, a robot, and a drone. In addition, a part of the control system according to the present invention may be mounted in such a mobile object or may be not mounted therein. Furthermore, the present invention can be applied also to a case in which a mobile object is remotely controlled.

While the present invention has been described with reference to exemplary embodiments, it is to be understood that the invention is not limited to the disclosed exemplary embodiments. The scope of the following claims is to be accorded the broadest interpretation to encompass all such modifications and equivalent structures and functions.

In addition, as a part or the whole of the control according to the embodiments, a computer program realizing the function of the embodiments described above may be supplied to the control system through a network or various storage media. Then, a computer (or a CPU, an MPU, or the like) of the control system may be configured to read and execute the program. In such a case, the program and the storage medium storing the program configure the present invention.

In addition, the present invention includes those realized using at least one processor or circuit configured to perform functions of the embodiments explained above. For example, a plurality of processors may be used for distribution processing to perform functions of the embodiments explained above.

Priority is claimed on Japanese Patent Application No. 2022-014166, filed Feb. 1, 2022, Japanese Patent Application No. 2022-117189, filed Jul. 22, 2022, and Japanese Patent Application No. 2023-001617, filed Jan. 10, 2023, which have been filed in advance. In addition, the entire contents of the Japanese Patent Applications described above are incorporated herein by reference.

What is claimed is:

1. A control system comprising:
a control unit configured to give a control instruction to at least one or more mobile object; and
a conversion information storing unit configured to convert space information including information relating to a type of object present in a space defined using a first reference system and information relating to a time into a format in association with a unique identifier and storing the format,
wherein the conversion information storing unit is able to convert space information including information relating to a type of object present in a space defined using a second reference system different from the first reference system and information relating to a time into a format in association with a unique identifier and store the format,
the control system further comprising an association unit configured to associate the second reference system with the first reference system,
wherein the control unit generates route information relating to a movement route of the mobile object on the basis of the space information acquired from the conversion information storing unit and the type information of the mobile object.

2. The control system according to claim 1, wherein the association unit associates the second reference system with the first reference system by registering reference parameters of the second reference system in the first reference system.

3. The control system according to claim 2, wherein the reference parameters include at least a position of an origin, setting specifications of coordinate axes, an assignment rule for unique identifiers, a reference position of a divided space, and an estimation method for a self-position for the reference system represented by the reference parameters.

4. The control system according to claim 1, wherein the first reference system and the second reference system have a hierarchical structure.

5. The control system according to claim 1, wherein the association unit associates the first reference system with the second reference system by registering reference parameters of the second reference system in the first reference system and registering the reference parameters of the first reference system in the second reference system.

6. The control system according to claim 1, wherein the first reference system and the second reference system include at least one of a coordinate system defined using latitude/longitude/height, an arbitrary XYZ coordinate system, an MGRS, a pixel coordinate system, and a tile coordinate system.

7. The control system according to claim 1, wherein a gap between pieces of position point group data configuring the movement route is configured to be adjustable.

8. A control method comprising:
a control process of giving a control instruction to at least one or more mobile objects; and
a conversion information storing process of converting space information including information relating to a type of object present in a space defined using a first reference system and information relating to a time into a format in association with a unique identifier and storing the format,
wherein the conversion information storing process is able to convert space information including information relating to a type of object present in a space defined using a second reference system different from the first reference system and information relating to a time into a format in association with a unique identifier and store the format,
the control method further comprising an association process of associating the second reference system with the first reference system,
wherein the control process generates route information relating to a movement route of the mobile object on the basis of the space information acquired in the conversion information storing process and the type information of the mobile object.

9. A non-transitory computer-readable storage medium configured to store a computer program comprising instructions for executing following processes:
a control process of giving a control instruction to at least one or more mobile objects; and
a conversion information storing process of converting space information including information relating to a type of object present in a space defined using a first reference system and information relating to a time into a format in association with a unique identifier and storing the format,
wherein the conversion information storing process is able to convert space information including information relating to a type of object present in a space defined using a second reference system different from the first reference system and information relating to a time into a format in association with a unique identifier and store the format
the control method further comprising an association process of associating the second reference system with the first reference system,
wherein the control process generates route information relating to a movement route of the mobile object on the basis of the space information acquired in the conversion information storing process and the type information of the mobile object.
